(19) United States
(12) Patent Application Publication
(10) Pub. No.: US 2012/0061083 A1
(43) Pub. Date: Mar. 15, 2012

(54) WELLBORE FLUID AND METHODS OF TREATING AN EARTHEN FORMATION

(75) Inventor: David Antony Ballard, Stonehaven (GB)

(73) Assignee: M-I DRILLING FLUIDS UK LIMITED, Aberdeen (GB)

(21) Appl. No.: 13/201,770

(22) PCT Filed: Feb. 22, 2010
(86) PCT No.: PCT/GB2010/000311

§ 371 Date: Nov. 7, 2011

(30) Foreign Application Priority Data
Feb. 20, 2009 (GB) 0902931.5

(51) Int. Cl. E21B 43/16; C09K 8/22; C09K 8/08; E21B 43/00

(52) U.S. Cl. 166/305.1; 166/310; 507/131; 507/133; 507/110

(57) ABSTRACT

The present application describes improved compositions for wellbore fluids for use in downhole (e.g. oilwell) applications. The compositions comprise a blocked isocyanate (BI) component having a tolerance improving group (such as a hydrophilic group, e.g. an amine) bonded to it, and an active hydrogen component. When the BI group is unblocked, it reacts with the active hydrogen component to form a gel which, by virtue of the tolerance improving group, is more tolerant to contaminants (such as aqueous inorganic salts or brines) than the corresponding gel forms from unmodified BI. The application also relates to methods of treating an earthen formation using such a composition.

### FIELD OF INVENTION

The present developments relate to polymeric compositions for wellbore fluids used in downhole applications and methods of treatment of an earthen formation using such fluids.

### BACKGROUND

Lost circulation is a recurring drilling problem, characterized by loss of drilling mud into downhole formations that are fractured, highly permeable, porous, cavernous, or vugular. These earth formations can include shale, sands, gravel, shell beds, reef deposits, limestone, dolomite, and chalk, among others. Other problems encountered while drilling and producing oil and gas include stuck pipe, hole collapse, loss of well control, and loss of or decreased production.

Induced mud losses may also occur when the mud weight, required for well control and to maintain a stable wellbore, exceeds the fracture resistance of the formations. A particularly challenging situation arises in depleted reservoirs, in which the drop in pore pressure weakens hydrocarbon-bearing rocks, but neighbouring or inter-bedded low permeability rocks, such as shales, maintain their pore pressure. This can make the drilling of certain depleted zones impossible because the mud weight required to support the shale exceeds the fracture resistance of the sands and silts.

Other situations arise in which isolation of certain zones within a formation may be beneficial. For example, one method to increase the production of a well is to perforate the well in a number of different locations, either in the same hydrocarbon bearing zone or in different hydrocarbon bearing zones, and thereby increase the flow of hydrocarbons into the well. The problem associated with producing from a well in this manner relates to the control of the flow of fluids from the well and to the management of the reservoir. For example, in a well producing from a number of separate zones (or from laterals in a multilateral well) in which one zone has a higher pressure than another zone, the higher pressure zone may disembogue into the lower pressure zone rather than to the surface. Similarly, in a horizontal well that extends through a single zone, perforations near the “heel” of the well, i.e., nearer the surface, may begin to produce water before those perforations near the “toe” of the well. The production of water near the heel reduces the overall production from the well.

During the drilling process muds are circulated downhole to remove rock as well as deliver agents to combat the variety of issues described above. Mud compositions may be water or oil-based (including mineral oil, biological, diesel, or synthetic oils) and may comprise weighting agents, surfactants, proppants, and gels. In attempting to cure these and other problems, crosslinkable or absorbing polymers, loss control material (LCM) pills, and cement squeezes have been employed. Gels, in particular, have found utility in preventing mud loss, stabilizing and strengthening the wellbore, and zone isolation and water shutoff treatments.

In attempting to cure these and other problems, the majority of gels employ water compatible gelling and crosslinking agents, as exemplified by U.S. Patent Application Publication No. 20060011343 and U.S. Pat. Nos. 7,008,908 and 6,165,947, which are useful when using water-based muds. Isocyanate-based gels have also been investigated (e.g. as described in International Application No. PCT/US2008/061272) and have shown promise as wellbore treatment fluids that can be formulated to be compatible with oil-based or water-based muds.

Wellbore fluids that can form isocyanate gels downhole comprise an isocyanate component and an active hydrogen component. Typically these components are dissolved or suspended in a fluid medium. Downhole, the isocyanate component reacts with the compound having an active hydrogen group to form a polymeric gel.

As known in the art, the term “active hydrogen compound” refers to a compound that will give up or transfer a hydrogen atom to another substance.

The reaction between the isocyanate component and the active hydrogen component proceeds by the active hydrogen atom-containing nucleophilic centre attacking the electrophilic carbon atom of the isocyanate, and the active hydrogen atom being added to the nitrogen atom of the isocyanate as shown below in scheme 1:

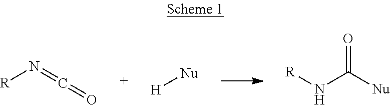

In some cases, for example where the isocyanate is a polyisocyanate, this reaction may result in a polymeric product or gel.

The isocyanate may be blocked with a blocking group B to prevent this reaction occurring until the blocking group is removed, e.g. downhole by heat, as shown in scheme 2:

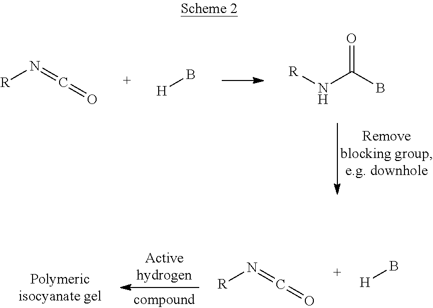

However, such blocked isocyanate wellbore fluids can be unstable and may also degrade in the presence of contaminants that are commonly found in wellbore applications (such as seawater, calcium chloride brine, calcium bromide brine, sodium chloride brine, potassium chloride brine, magnesium ion brines, cement slurry, potassium formate brines and naturally occurring contaminants from salt domes being drilled) and do not form a stable polymeric gel. Instead they can coagulate to form lumpy compositions that typically separate into a solids component and a liquid component and do not provide the desired support for the well formation.

Therefore, there is a need for wellbore treatment systems that form a gel downhole and show increased tolerance to the presence of contaminants (such as seawater, calcium chloride brine, calcium bromide brine, sodium chloride brine, potassium chloride brine, magnesium ion brines, cement slurry, potassium formate brines and naturally occurring contaminants from salt domes being drilled).

### SUMMARY

The present developments relate to new and useful wellbore fluids that are tolerant to downhole contaminants. The present application also includes methods of treating earthen formations using such fluids.

In one aspect, the present developments relate to a wellbore fluid comprising a blocked isocyanate having a tolerance improving group bonded to it, and an active hydrogen component. The tolerance improving group adjusts the nature of the blocked isocyanate group to make the wellbore fluid more tolerant to the presence of contaminants (such as seawater, calcium chloride brine, calcium bromide brine, sodium chloride brine, potassium chloride brine, magnesium ion brines, cement slurry, potassium formate brines and naturally occurring contaminants from salt domes being drilled).

In a further aspect, these developments relate to methods of treating an earthen formation comprising introducing a blocked isocyanate having a tolerance improving group grafted to it into the earthen formation; introducing an active hydrogen component into the earthen formation; and initiating a reaction of the blocked isocyanate with the active hydrogen component to form a polymeric gel.

In some cases, the blocked isocyanate having the tolerance improving group bonded to it may be mixed with the active hydrogen component before being introduced into the earthen formation, i.e. the two are introduced as a single fluid, and the reaction initiation to form the polymeric gel occurs downhole. In other cases, the two components (the blocked isocyanate having the tolerance improving groups bonded to it and the active hydrogen compound) are contacted downhole where they react to form a gel.

### BRIEF DESCRIPTION OF THE FIGURES

FIG. 1 shows a summary of hardness values obtained with the best performing amines for the compositions of Example 1. Gel hardness is shown after aging at 170° C. with different amines at different concentrations in a Xanthan gum base.

FIG. 2 shows a summary of the peak gel hardness for Trixene 7987 and LDP437 gels in Biovis and HEC bases with different amounts of amine gelling agents.

FIG. 3 shows the gel hardness of a Trixene BI when modified with various different amines and reacted with different amounts of ED2003 amine to form a gel.

FIG. 4 shows the gel hardness of the Trixene BI modified to different extents with two different amines and reacted with ED2003 to form a gel.

FIG. 5 shows gel hardness of a Trixene BI gel formed with Jeffamine ED2003 with different additives, including Aerosil 200 and Biovis. The stability of the gel is tested with the Aerosil added before or after modification of the Trixene 7987 BI with 5% Jeffamine M2070. Gel hardness in the presence of CaCl₂ brine is also shown.

FIG. 6 shows consistomer plots for Trixene 7987 BI modified with 5% Jeffamine M2070 and 1.5% Biovis (scleroglucan) compared to the situation in which extra Jeffamine M2070 is added to the composition.

### DETAILED DESCRIPTION

Embodiments disclosed herein relate to wellbore fluids for use in downhole applications wherein the wellbore fluid can form a polymeric gel downhole. Other embodiments of the disclosure relate to methods for producing polymeric gels and methods for using such gels in downhole applications.

The present applicants have found that the tolerance of wellbore fluids comprising an isocyanate or blocked isocyanate component and an active hydrogen component to contaminants can be improved by modifying the isocyanate or blocked isocyanate component by bonding to it a modifying group.

Improved Tolerance

A measure of the tolerance of a wellbore fluid to the presence of contaminants (such as seawater, calcium chloride brine, calcium bromide brine, sodium chloride brine, potassium chloride brine, magnesium ion brines, cement slurry, potassium formate brines and naturally occurring contaminants from salt domes being drilled) may be expressed as the ability of the composition to form a polymeric gel in the presence of contaminants on unblocking of the isocyanate. For example, compositions of the present invention (which have an improved tolerance to the presence of contaminants) preferably form a gel having a hardness of at least 50 gram-force, more preferably at least 100 gram-force, (measured by a Brookfield QTS-25 Texture Analysis Instrument as described below) whereas an equivalent composition that does not comprise the modifying group would either form a weaker gel (less than 50 gram-force or 100 gram-force) or not form a gel at all in the presence of contaminants.

Contaminant-tolerant wellbore compositions of the present invention are preferably homogeneous fluids prior to unblocking and preferably form a homogeneous gel on unblocking and reaction with an active hydrogen component.

Another measure of the contaminant tolerance of a composition may be provided the level of contaminant that can be added to the composition before it fails to form a gel on unblocking. In preferred embodiments, the present compositions will form a gel in the presence of contaminant levels of up to about 0.5% w/v and preferably up to about 0.7% w/v, more preferably up to about 1 or 1.5% w/v.

Isocyanates

Isocyanates useful in embodiments disclosed herein may include isocyanates, polyisocyanates, and isocyanate prepolymers. Suitable polyisocyanates include any of the known aliphatic, alicyclic, cycloaliphatic, araliphatic, and aromatic di- and/or polyisocyanates. Inclusive of these isocyanates are variants such as uretdiones, biurets, allophanates, isocyanurates, carbodiimides, and carbamates, among others.

Aliphatic polyisocyanates may include hexamethylene diisocyanate, trimethylhexamethylene diisocyanate, dimeric acid diisocyanate, lysine diisocyanate, long chain isocyanates and polyisocyanates (e.g. C₃₆ diisocyanate), and the like, and biuret-type adducts and isocyanurate ring adducts of these polyisocyanates. Alicyclic diisocyanates may include isophorone diisocyanate, 4,4′methylenebis(cyclohexylisocyanate), methylcyclohexane-2,4- or -2,6-diisocyanate, 1,3- or 1,4-di(isocyanatomethyl)cyclohexane, 1,4-cyclohexane diisocyanate, 1,3-cyclopentane diisocyanate, 1,2-cyclohexane diisocyanate, and the like, and biuret type adducts and isocyanurate ring adducts of these polyisocyanates. Aromatic diisocyanate compounds may include xylylene diisocyanate, metaxylylene diisocyanate, tetramethylxylylene diisocyanate, tolylene diisocyanate, 4,4′-diphenylmethane diisocyanate, 1,5-naphthalene diisocyanate, 1,4-naphthalene diisocyanate, 4,4′-toluydine diisocyanate, 4,4′-diphenyl ether diisocyanate, m- or p-phenylene diisocyanate, 4,4′-biphenylene diisocyanate, 3,3′-dimethyl-4,4′-biphenylene diisocyanate, bis(4-isocyanatophenyl)-sulfone, isopropylidenebis (4-phenylisocyanate), and the like, and biuret type adducts and isocyanurate ring adducts of these polyisocyanates.

Polyisocyanates having three or more isocyanate groups per molecule may include, for example, triphenylmethane-4,4′,4″-triisocyanate, 1,3,5-triisocyanato-benzene, 2,4,6-triisocyanatotoluene, 4,4′-dimethyldiphenylmethane-2,2′,5,5′-tetraisocyanate, and the like, biuret type adducts and isocyanurate ring adducts of these polyisocyanates.

Additionally, isocyanate compounds used herein may include urethanation adducts formed by reacting hydroxyl groups of polyols such as ethylene glycol, propylene glycol, 1,4-butylene glycol, dimethylolpropionic acid, polyalkylene glycol, trimethylolpropane, hexanetriol, and the like with the polyisocyanate compounds, and biuret type adducts and isocyanurate ring adducts of these polyisocyanates.

Other isocyanate compounds may include tetramethylene diisocyanate, toluene diisocyanate, hydrogenated diphenylmethane diisocyanate, hydrogenated xylylene diisocyanate, and trimers of these isocyanate compounds; terminal isocyanate group-containing compounds obtained by reacting the above isocyanate compound in an excess amount and a low molecular weight active hydrogen compound (e.g., ethylene glycol, propylene glycol, trimethylolpropane, glycerol, sorbitol, ethylenediamine, monoethanolamine, diethanolamine, triethanolamine etc.) or high molecular weight active hydrogen compounds such as polyesterpolyols, polyetherpolyols, polyamides and the like may be used in embodiments disclosed herein.

Other useful polyisocyanates include, but are not limited to 1,2-ethylenediisocyanate, 2,2,4- and 2,4,4-trimethyl-1,6-hexamethylenediisocyanate, 1,12-dodecandiisocyanate, omega, omega-diisocyanatodipropylether, cyclobutan-1,3-diisocyanate, cyclohexan-1,3- and 1,4-diisocyanate, 2,4- and 2,6-diisocyanato-1-methylcylcohexane, 3-isocyanatomethyl-3,5,5-trimethylcyclohexylisocyanate (“isophoronediisocyanate”), 2,5- and 3,5-bis-(isocyanatomethyl)-8-methyl-1,4-methano, decahydronaphthathalin, 1,5-, 2,5-, 1,6- and 2,6-bis-(isocyanatomethyl)-4,7-methanohexahydroindan, 1,5-, 2,5-, 1,6- and 2,6-bis-(isocyanato)-4,7-methanohexahydroindan, dicyclohexyl-2,4′- and -4,4′-diisocyanate, omega, omega-diisocyanato-1,4-diethylbenzene, 1,3- and 1,4-phenylenediisocyanate, 4,4′diisocyanatodiphenyl, 4,4′-diisocyanato-3,3′-dichlorodiphenyl, 4,4′-diisocyanato-3,3′-methoxy-diphenyl, 4,4′-diisocyanato-3,3′-diphenyl-diphenyl, naphthalene-1,5-diisocyanate, N—N′-(4,4′-dimethyl-3,3′-diisocyanatodiphenyl)-uretdione, 2,4,4′-triisocyanatano-diphenylether, 4,4′,4″-triisocyanatotriphenylmethane, and tris(4-isocyanatophenyl)-thiophosphate.

Other suitable polyisocyanates may include: 1,8-octamethylenediisocyanate; 1,11-undecane-methylenediisocyanate; 1,12-dodecamethylendiisocyanate; 1-isocyanato-3-isocyanatomethyl-3,5,5-trimethylcyclohexane; 1-isocyanato-1-methyl-4(3)-isocyanatomethylcyclohexane; 1-isocyanato-2-isocyanatomethylcyclopentane; (4,4′- and/or 2,4′-) diisocyanato-dicyclohexylmethane; bis-(4-isocyanato-3-methylcyclohexyl)-methane; a,a,a′,a′-tetramethyl-1,3- and/or -1,4-xylylenediisocyanate; 1,3 and/or 1,4-hexahydroxylylene-diisocyanate; 2,4- and/or 2,6-hexahydrotoluenediisocyanate; 2,4- and/or 2,6-toluene-diisocyanate; 4,4′- and/or 2,4′-diphenylmethanediisocyanate; n-isopropenyl-dimethylbenzyl-isocyanate; any double bond containing isocyanate; and any of their derivatives having urethane-, isocyanurate-, allophanate-, biuret-, uretdione-, and/or iminooxadiazindione groups.

Polyisocyanates may also include aliphatic compounds such as trimethylene, pentamethylene, 1,2-propylene, 1,2-butylene, 2,3-butylene, 1,3-butylene, ethylidene and butylidene diisocyanates, and substituted aromatic compounds such as dianisidine diisocyanate, 4,4′-diphenylether diisocyanate and chlorodiphenylene diisocyanate.

Other isocyanate compounds are described in, for example, U.S. Pat. Nos. 6,288,176, 5,559,064, 4,637,956, 4,870,141, 4,767,829, 5,108,458, 4,976,833, and 7,157,527, U.S. Patent Application Publication Nos. 20050187314, 20070023288, 20070009750, 20060281854, 20060148391, 20060122357, 20040236021, 20020028932,20030194635, and 20030004282, each of which is hereby incorporated by reference. Isocyanates formed from polycarbamates are described in, for example, U.S. Pat. No. 5,453,536, hereby incorporated by reference herein. Carbonate isocyanates are described in, for example, U.S. Pat. No. 4,746,754, herby incorporated by reference herein.

Particularly preferred isocyanates include hexamethylene diisocyanate (HDI), in particular HDI trimers, toluene diisocyanate (TDI), isophorone diisocyanate (IPDI), methylene diphenyl diisocyanate (MDI) and tetramethylxylene diisocyanate (TMXDI). Especially preferred is a hexamethylene diisocyanate trimer such as that forming the backbone of the blocked isocyanate available under the trade name Trixene®, e.g. Trixene 7987, from Baxenden Chemicals Limited (Accrington, England).

In order to prevent premature reaction with the active hydrogen compound, and thus gelation, or reaction with any water that may likely be present in the wellbore, the isocyanate pumped downhole for formation of an elastomeric gel is preferably a blocked isocyanate.

Blocked Isocyanates and Blocking Groups

Blocked isocyanates are typically manufactured starting from acidic hydrogen containing compounds such as phenol, ethyl acetoacetate and e-caprolactam. Typical unblock temperatures range between 90 to 200° C., depending on the isocyanate structure and blocking agent. For example, aromatic isocyanates are typically unblocked at lower temperatures than those required to unblock aliphatic isocyanates. The dissociation temperature decreases according to the following order of blocking agents: alcohols>lactams>phenols>oximes>pyrazoles>active methylene group compounds. Products such as methylethylketoxime (MEKO), diethyl malonate (DEM) and 3,5-dimethylpyrazole (DMP) are typical blocking agents used, for example, by Baxenden Chemicals Limited (Accrington, England). DMP's unblock temperature is in the range 110-120° C., melting point is 106° C. and boiling point is high, 218° C., without film surface volatilization problems. Trixene prepolymers may include 3,5-dimethylpyrazole (DMP) blocked isocyanates, which are commercially available from Baxenden Chemicals Limited.

Suitable isocyanate blocking agents may include alcohols, ethers, phenols, malonate esters, methylenes, acetoacetate esters, lactams, oximes, and ureas, among others. Other blocking agents for isocyanate groups include compounds such as bisulphites, and phenols, alcohols, lactams, oximes and active methylene compounds, each containing a sulfone group. Also, mercaptans, triazoles, pyrrazoles, secondary amines, and also malonic esters and acetylacetic acid esters may be used as a blocking agent. The blocking agent may include glycolic acid esters, acid amides, aromatic amines, imides, active methylene compounds, ureas, diaryl compounds, imidazoles, carbamic acid esters, or sulfites.

For example, phenolic blocking agent may include phenol, cresol, xylenol, chlorophenol, ethylphenol and the like. Lactam blocking agent may include gamma-pyrrolidone, laurinlactam, epsilon-caprolactam, delta-valerolactam, gamma-butyrolactam, beta-propiolactam and the like. Methylene blocking agents may include acetoacetic ester, ethyl acetoacetate, acetyl acetone and the like. Oxime blocking agents may include formamidoxime, acetaldoxime, acetoxime, methylethylketoxine, diacetylmonoxime, cyclohexanoxime, 2,6-dimethyl-4-heptanone oxime, methyl ethyl ketoxime, 2-heptanone oxime and the like; mercaptan blocking agent such as butyl mercaptan, hexyl mercaptan, t-butyl mercaptan, thiophenol, methylthiophenol, ethylthiophenol and the like. Acid amide blocking agents may include acetic acid amide, benzamide and the like. Imide blocking agents may include succinimide, maleimide and the like. Amine blocking agents may include xylidine, aniline, butylamine, dibutylamine diisopropyl amine and benzyl-tert-butyl amine and the like. Imidazole blocking agents may include imidazole, 2-ethylimidazole and the like. Imine blocking agents may include ethyleneimine, propyleneimine and the like. Triazoles blocking agents may include compounds such as 1,2,4-triazole, 1,2,3-benzotriazole, 1,2,3-tolyl triazole and 4,5-diphenyl-1,2,3-triazole.

Alcohol blocking agents may include methanol, ethanol, propanol, isopropanol, butanol, t-butanol, n-butanol, hexanol, n-hexanol, pentanol, n-pentanol, amyl alcohol, ethylene glycol monomethyl ether, ethylene glycol monoethyl ether, ethylene glycol monobutyl ether, diethylene glycol monomethyl ether, propylene glycol monomethyl ether, benzyl alcohol, methyl glycolate, butyl glycolate, diacetone alcohol, methyl lactate, ethyl lactate and the like. Additionally, any suitable aliphatic, cycloaliphatic or aromatic alkyl monoalcohol may be used as a blocking agent in accordance with the present disclosure. For example, aliphatic alcohols, such as methyl, ethyl, chloroethyl, propyl, butyl, amyl, hexyl, heptyl, octyl, nonyl, 3,3,5-trimethylhexyl, decyl, and lauryl alcohols, and the like may be used. Suitable cycloaliphatic alcohols include, for example, cyclopentanol, cyclohexanol and the like, while aromatic-alkyl alcohols include phenylcarbinol, methylphenylcarbinol, and the like.

Examples of suitable dicarbonylmethane blocking agents include: malonic acid esters such as diethyl malonate, dimethyl malonate, di(iso)propyl malonate, di(iso)butyl malonate, di(iso)pentyl malonate, di(iso)hexyl malonate, di(iso)heptyl malonate, di(iso)octyl malonate, di(iso)nonyl malonate, di(iso)decyl malonate, alkoxyalkyl malonates, benzylmethyl malonate, di-tert-butyl malonate, ethyl-tertbutyl malonate, dibenzyl malonate; and acetylacetates such as methyl acetoacetate, ethyl acetoacetate, propyl acetoacetate, butyl acetoacetate and alkoxyalkylacetoacetates; cyanacetates such as cyanacetic acid ethylester; acetylacetone; 2,2-dimethyl-1,3-dioxane-4,6-dione; methyl trimethylsilyl malonate, ethyl trimethylsilyl malonate, and bis(trimethylsilyl)malonate.

Malonic or alkylmalonic acid esters derived from linear aliphatic, cycloaliphatic, and/or arylalkyl aliphatic alcohols may also be used. Such esters may be made by alcoholysis using any of the above-mentioned alcohols or any monoalcohol with any of the commercially available esters (e.g., diethylmalonate). For example, diethyl malonate may be reacted with 2-ethylhexanol to obtain the bis(2-ethylhexyl)-malonate. It is also possible to use mixtures of alcohols to obtain the corresponding mixed malonic or alkylmalonic acid esters. Suitable alkylmalonic acid esters include: butyl malonic acid diethylester, diethyl ethyl malonate, diethyl butyl malonate, diethyl isopropyl malonate, diethyl phenyl malonate, diethyl n-propyl malonate, diethyl isopropyl malonate, dimethyl allyl malonate, diethyl chloromalonate, and dimethyl chloro-malonate.

Other isocyanate blocking agents are described in, for example, U.S. Pat. Nos. 6,288,176, 5,559,064, 4,637,956, 4,870,141, 4,767,829, 5,108,458, 4,976,833, and 7,157,527, U.S. Patent Application Publication Nos. 20050187314, 20070023288, 20070009750, 20060281854, 20060148391, 20060122357, 20040236021, 20020028932, 20030194635, and 20030004282, each of which is incorporated herein by reference. Further, one of ordinary skill in the art would appreciate that mixtures of the above-listed isocyanate blocking agents may also be used.

In some embodiments, blocked polyisocyanate compounds may include, for example, polyisocyanates having at least two free isocyanate groups per molecule, where the isocyanate groups are blocked with an above-described isocyanate blocking agent.

Blocked isocyanates may be prepared by reaction of one of the above-mentioned isocyanate compounds and a blocking agent by a conventionally known appropriate method. In other embodiments, the blocked isocyanates used in embodiments disclosed herein may be any isocyanate where the isocyanate groups have been reacted with an isocyanate blocking compound so that the resultant capped isocyanate is stable to active hydrogens at room temperature but reactive with active hydrogens when the blocking group is removed, e.g. at elevated temperatures, such as between about 65° C. to 200° C. U.S. Pat. No. 4,148,772, for example, describes the reaction between polyisocyanates and capping agent, fully or partially capped isocyanates, and the reaction with or without the use of a catalyst, and is incorporated herein by reference.

Blocked polyisocyanate compounds are typically stable at room temperature. When heated, for example, to 70° C. or above in some embodiments, or to 120° C., 130° C., 140° C. or above in other embodiments, the blocking agent is dissociated to regenerate the free isocyanate groups, which may readily react with active hydrogen compounds, typically compounds containing hydroxyl groups (in which case polyurethanes are formed).

As an alternative to an external or conventional blocking agent, the isocyanates may be internally blocked. The term internally blocked, as used herein, indicates that there are uretdione groups present which unblock at certain temperatures to free the isocyanate groups for cross-linking purposes. Isocyanate dimers (also referred to as uretdiones) may be obtained by dimerizing diisocyanates in the presence of phosphine catalysts. The dimerization is reversible such that under mild heat, monomeric isocyanates are obtained.

Preferred blocking groups include methyl ethyl ketoxime and 3,5-dimethyl pyrazole.

Preferred blocked isocyanate compounds include toluene diisocyanate blocked with methyl ethyl ketoxime (available as LDP 437 from Lamberti SpA based in Italy) and hexamethylene diisocyanate trimer blocked with 3,5-dimethyl pyrazole (available as Trixene ® 7987 from Baxenden Chemicals Limited). Other blocked isocyanates from the Trixene® range (Baxenden Chemicals Limited) are also suitable.

Active Hydrogen Compounds

As described above, active hydrogen compounds such as polyols and polyamines may be reacted with an isocyanate, such as those disclosed herein, to form a polyurethane gel and polyurea gel, respectively. In general terms, the active hydrogen compounds preferably have at least one hydroxyl or amine functional group.

Aliphatic polyols useful in preparing polyurethane gels may have a molecular weight of 62 up to 2000 and include, for example, monomeric and polymeric polyols having two or more hydroxyl groups. Examples of the monomeric polyols include ethylene glycol, propylene glycol, butylene glycol, hexamethylene glycol, cyclohexamethylenediol, 1,1,1-trimethylolpropane, pentaerythritol, and the like. Examples of polymeric polyols include the polyoxyalkylene polyols (i.e., the diols, triols, and tetrols), the polyester diols, triols, and tetrols of organic dicarboxylic acids and polyhydric alcohols, and the polylactone diols, triols, and tetrols having a molecular weight of 106 to about 2000. Other examples of suitable polyols include: glycerine monoalkanoates (e.g., glycerine monostearates); dimer fatty alcohols; diethylene glycol; triethylene glycol; tetraethylene glycol; 1,4-dimethylolcyclohexane; dodecanediol; bisphenol-A; hydrogenated bisphenol A; 1,3-hexanediol; 1,3-octanediol; 1,3-decanediol; 3-methyl-1,5-pentanediol; 3,3-dimethyl-1,2-butanediol; 2-methyl-1,3-pentanediol; 2-methyl-2,4-pentanediol; 3-hydroxymethyl-4-heptanol; 2-hydroxymethyl-2,3-dimethyl-1-pentanol; glycerine; trimethylol ethane; trimethylol propane; trimerized fatty alcohols; isomeric hexanetriols; sorbitol; pentaerythritol; di- and/or tri-methylolpropane; dipentaerythritol; diglycerine; 2,3-butenediol; trimethylol propane monoallylether; fumaric and/or maleinic acid containing polyesters; 4,8-bis-(hydroxymethyl)tricyclo[5,2,0(2,6)]-decane long chain alcohols. Suitable hydroxy-functional esters may be prepared by the addition of the above-mentioned polyols with epsilon-caprolactone or reacted in a condensation reaction with an aromatic or aliphatic diacid. These polyols may be reacted with any of the isocyanates described above.

Aliphatic polyamines useful in preparing polyureas may have a molecular weight of 60 to 2000 and include monomeric and polymeric primary and secondary aliphatic amines having at least two amino groups. Examples include alkylene diamines such as ethylene diamine; 1,2-diaminopropane; 1,3-diaminopropane; 2,5-diamino-2,5-dimethylhexane; 1,11-diaminoundecane; 1,12-diaminododecane; piperazine, as well as other aliphatic polyamines such as polyethylenimines (PEI), which are ethylenediamine polymers and are commercially available under the trade name Lupasol® from BASF (Germany). PEIs may vary in degree of branching and therefore may vary in degree of crosslinking. LUPASOL® PEIs may be small molecular weight constructs such as LUPASOL® FG with an average molecular weight of 800 or large molecular weight constructs such as LUPASOL® SK with average molecular weight of 2,000,000. Cycloaliphatic diamines suitable for use may include those such as isophoronediamine; ethylenediamine; 1,2-propylenediamine; 1,3-propylenediamine; N-methyl-propylene-1,3-diamine; 1,6-hexamethylenediamine; 1,4-diaminocyclohexane; 1,3-diaminocyclohexane; N,N′-dimethylethylenediamine; and 4,4′-dicyclohexyl-methanediamine for example, in addition to aromatic diamines, such as 2,4-diaminotoluene; 2,6-diaminotoluene; 3,5-diethyl-2,4-diaminotoluene; and 3,5-diethyl-2,6-diaminotoluene for example; and primary, mono-, di-, tri- or tetraalkyl-substituted 4,4′-diamino-diphenylmethanes. Additionally, while many diamines are listed above, one of ordinary skill in the art would appreciate that tri- and tetraamines may also be used in other embodiments of the present disclosure.

In yet another embodiment the aliphatic amine may be a polyetheramine such as those commercially available under the trade name JEFFAMINE® Huntsman Performance Products (Woodlands, Tex.). For example, useful JEFFAMINE® products may include triamines JEFFAMINE® T-5000 and JEFFAMINE® T-3000 or diamines such as JEFFAMINE® D-400 and JEFFAMINE® D-2000. Useful polyetheramines may possess a repeating polyether backbone and may vary in molecular weight from about 200 to about 5000 g/mol. In addition, hydrazino compounds such as adipic dihydrazide or ethylene dihydrazine may be used, as may also, alkanolamines such as ethanolamine, diethanolamine, and tris(hydroxyethyl)ethylenediamine.

Further, one of ordinary skill in the art would appreciate that, in various embodiments, it may be desirable to possess additional control over the curing reaction to produce the polymeric, preferably elastomeric, gel. Such control may be obtained, for example, by using less chemically reactive amine structures, such as secondary amines, amines immobilized in a molecular sieve, or other less reactive or “slower amines” that may be known in the art. Suitable secondary amines may include those supplied by Huntsman Performance Products (Woodlands, Tex.), under the JEFFAMINE® SD product family, such as JEFFAMINE® SD-401 and JEFFAMINE® SD-2001.

Additionally, it is also within the scope of the present disclosure that one or more epoxy resins may be present in the mixture of isocyanate and active hydrogen compound. Inclusion of an epoxy resin may allow for the formation of a polyurethane or polyurea/epoxide hybrid gel. Conventionally, due to the higher reactivity of isocyanates, as compared to epoxides, isocyanates will react with active hydrogen compounds as described above prior to reaction of epoxides with available active hydrogen compounds (which may include non-reacted active hydrogens included in the mixture or active hydrogens that have been generated in the isocyanate-polyol/polyamine reaction).

The epoxy resin component may be any type of epoxy resin useful in molding compositions, including any material containing one or more reactive oxirane groups, referred to herein as “epoxy groups” or “epoxy functionality.” Epoxy resins useful in embodiments disclosed herein may include mono-functional epoxy resins, multi- or poly-functional epoxy resins, and combinations thereof. Monomeric and polymeric epoxy resins may be aliphatic, cycloaliphatic, aromatic, or heterocyclic epoxy resins. The polymeric epoxies include linear polymers having terminal epoxy groups (a diglycidyl ether of a polyoxyalkylene glycol, for example), polymer skeletal oxirane units (polybutadiene polyepoxide, for example) and polymers having pendant epoxy groups (such as a glycidyl methacrylate polymer or copolymer, for example). The epoxies may be pure compounds, but are generally mixtures or compounds containing one, two or more epoxy groups per molecule. For example, such epoxy compounds may also include compounds such as ethylene glycol diglycidyl ether, propylene glycol diglycidyl ether, butylene glycol diglycidyl ether, sorbitol polyglycidyl ether, epoxy functionalized polyalkalene glycols, trimethylolpropane triglycidyl ether, diglycidyl ether of neopentyl glycol, epoxidized 1,6-hexanediol, 1,4-butanediol diglycidyl ether (BDDGE), 1,2,7,8-diepoxyoctane, 3-(bis(glycidoxymethyl)methoxy)-1,2-propanediol, 1,4-cyclohexanedimethanol diglycidyl ether, 4-vinyl-lcyclohexene diepoxide, 1,2,5,6-diepoxycyclooctane, and bisphenol A diglycidyl ether, or combinations thereof. In other embodiments, the epoxy compounds may include epoxidized natural oils such as those discussed in U.S. Patent Publication No. 2007/0287767, which is assigned to the present assignee and herein incorporated by reference in its entirety. In some embodiments, epoxy resins may also include reactive —OH groups, which may react at higher temperatures with anhydrides, organic acids, amino resins, phenolic resins, or with epoxy groups (when catalyzed) to result in additional crosslinking. In preferred embodiments, the active hydrogen compound is an amine, preferably a polyether amine. In particularly preferred embodiments, the active hydrogen compound is a polyether compound having a backbone comprising ethylene oxide (EO) and propylene oxide (PO) units with one or more amine groups attached thereto. Suitable amine active hydrogen compounds are mentioned above but, particularly suitable are polyether diamines having a hydrophilic PEG backbone, e.g. those sold under the trade name JEFFAMINE ® ED series amines (e.g. ED600, ED900 or ED2003) and ELASTAMINE® (e.g. HE1000 which is a mixture of di- and tri-amines based on a PEG backbone with a molecular weight of about 1000) by Huntsman Performance Products (Woodlands, Tex.). Particularly preferred is the JEFFAMINE® ED 2003 product which is a diamine having a backbone formed from EO and PO groups in the ratio EO/PO of 39/6 and a molecular weight of about 2000.

Stabilisers

The instability of blocked isocyanate wellbore fluids in the presence of certain downhole contaminants (e.g. seawater, calcium chloride brine, calcium bromide brine, sodium chloride brine, potassium chloride brine, magnesium ion brines, cement slurry, potassium formate brines and/or naturally occurring contaminants from salt domes being drilled) may be addressed in one of two different ways. The stability of the isocyanates in the presence of such contaminants may be increased by “external” modification of the wellbore fluid (i.e. addition of a stabilising component to the wellbore fluid mixture) or by “internal” modification of the blocked isocyanate (i.e. the blocked isocyanate itself is chemically altered to enhance the stability of the wellbore fluid).

In some embodiments, the wellbore fluid includes one or more external stabilisers. Preferably, these are viscosity enhancers that increase the viscosity of the wellbore fluid and, may preferably also increase the hardness of the polymeric gel formed by the fluid and, preferably, also the tolerance of the wellbore fluid to contaminants (such as contaminants found downhole).

Preferably the blocked isocyanate is internally modified to enhance the stability (e.g. less coagulation of the fluid before unblocking, more homogeneous gel and/or harder gel formed following reaction with the active hydrogen component) of the wellbore fluid in the presence of contaminants.

A wide range of different tolerance improving groups can be used to adjust the properties of the blocked isocyanate (preferably by bonding to the blocked isocyanate) and enhance the stability of the wellbore fluid in the presence of contaminants.

Tolerance Improving Groups

When the stability of the wellbore fluid in the presence of contaminants (in particular contaminants found downhole such as seawater, calcium chloride brine, calcium bromide brine, sodium chloride brine, potassium chloride brine, magnesium ion brines, cement slurry, potassium formate brines and naturally occurring contaminants from salt domes being drilled) is preferably enhanced by internal modification, i.e. the blocked isocyanate component of the present compositions has a tolerance improving group bonded to it.

Preferably the tolerance improving group is different to, and preferably chemically orthogonal to, the blocking group used so that each group can be independently attached and removed without affecting the other.

The tolerance improving group is preferably a hydrophilic group and is typically an amine.

The molecular weight of the amine may affect the time taken for the modified blocked isocyanate to form a gel on contact with the active hydrogen component or may affect the temperature at which the gel is formed. For example, if a low molecular weight amine component is used as the tolerance improving group, it may occupy a relatively large proportion of the available isocyanate functional groups on the blocked isocyanate. When the isocyanate is unblocked, there are then relatively few isocyanate groups available for reaction with the active hydrogen compound so the gel may be softer (fewer crosslinks) and/or take longer to harden and/or require a higher temperature to form a gel. The variation of the molecular weight of the tolerance improving group may be used to adjust the hardness and/or set time and/or set temperature of the polymeric gel formed by the wellbore fluid as desired.

In preferred embodiments, the amine is a high molecular weight amine, e.g. having a molecular weight of greater than about 150, greater than about 200, greater than about 500 or preferably greater than about 1000. The use of high molecular weight amines may result in an increased gel hardness and/or reduced set time and/or reduced gelation temperature of the wellbore fluid.

Mono amines or poly amines are suitable with polyamines, especially diamines, being preferred so that the tolerance improving group forms crosslinks between different isocyanate groups (either inter- or intra-molecularly). This is preferable as it tends to increase the hardness of the resulting gel.

In some embodiments, the tolerance improving groups are attached to the blocked isocyanate by bonding to one or more of the isocyanate groups (either before or after blocking). This may reduce the number of isocyanate groups available for reaction with the active hydrogen compound after unblocking.

In other embodiments, the tolerance improving groups may be bonded to the blocked isocyanate by reaction with a group other than one of the isocyanate functionalities, e.g. the tolerance improving group may be bonded to the backbone of a long-chain blocked isocyanate, leaving the isocyanate groups free (after unblocking) for reaction with the active hydrogen component.

The level of modification of the blocked isocyanate component may also be an important variable. It is preferred that the blocked isocyanate (BI) is modified with from greater than about 1% to about 40% of the tolerance improving groups, i.e. from about 1% to about 40% of the total isocyanate groups are modified with a tolerance improving group with the remaining isocyanate groups being blocked with blocking groups. If less than about 1% of the isocyanate groups are modified with tolerance improving groups, little improvement in the tolerance of the component to contaminants is seen. If more than about 40% of the isocyanate groups are modified with tolerance improving groups, the number of blocked isocyanate groups available for unblocking and subsequent reaction to form a gel is low so the resultant gels tend to be soft, in many cases too soft to be useful in wellbore applications. Preferably, about 2% to about 36% of the total isocyanate groups are modified with a tolerance improving group. More preferably, about 5% to about 25%, preferably about 10% to about 20% and more preferably about 15% to about 20%, most preferably about 18% of the isocyanate groups are modified with tolerance improving groups.

Suitable tolerance improving groups include alkyl mono-, di, tri, or poly-amines. Polyether amines are particularly preferred, such as amines having a backbone formed from ethylene oxide (EO) (i.e. poly ethylene glycol (PEG)), propylene oxide (PO) (i.e. polypropylene glycol (PPG)), and/or poly (tetramethylene ether glycol) (PTMEG) groups.

Examples of some suitable tolerance improving groups include:

Triethylene glycol diamine (TEGDA);

Alkanolamines, such as monoethanolamine (sold under the trade name PTS 100), diethanolamine, and triethanolamine;

Alkylalkanolamines, such as dimethylethanolamine, N-methyldiethanolamine, monomethylethanolamine diglycol amine and (2-2(aminoethoxy)ethanol);

Ethyleneamines, such as ethylenediamine, diethylenetriamine, triethylenetetramine, tetraethylenepentamine, ethyleneamine, aminoethylpiperazine, and aminoethylethanolamine [although these polyfunctional amines may be less desirable than monofunctional amines (or active hydrogen compounds) as they would tend to lead to a greater degree of cross-linking which takes up more isocyanate groups and leaves fewer for reaction after unblocking];

Polyetheramines, such as those available under the trade name JEFFAMINE® which contain primary amino groups attached at the end of a polyether chain which is made up of ethylene oxide (EO) and/or propylene oxide (PO) groups. Suitable amines from this range of products include:
JEFFAMINE® monoamines (M series in which the approximate molecular weight is indicated by the product number, e.g. M 600 has a molecular weight of about 600) such as M 600 (PO/EO ratio 9/1), M 1000 (PO/EO ratio 3/19), M 2005 (PO/EO ratio 29/6), M 2070 (PO/EO ratio 10/31);
JEFFAMINE® diamines (D (PO based), ED (EO/PO mixed backbone) and EDR (EO based) series in which the approximate molecular weight is indicated by the product number, e.g. D 230 has a molecular weight of about 230) such as D 230 (about 2.5 PO groups per molecule), D 400 (about 6.1 PO groups per molecule), D 2000 (about 33 PO groups per molecule), D 4000 (about 68 PO groups per molecule), ED 600 (PO/EO ratio 3.6/9), ED 900 (PO/EO ratio 6/12.5), ED 2003 (PO/EO ratio 6/39), EDR 148 (ethylene glycol bis(2-aminoethyl) ether), EDR 176 (ethylene glycol bis(2-aminopropyl) ether);
JEFFAMINE® HK 511 (which comprises ethylene oxide (EO) and propylene oxide (PO) groups in approximately a 2:1.2 ratio and has a molecular weight of about 200);
JEFFAMINE® triamines (propylene oxide based T series in which the approximate molecular weight is indicated by the product number, e.g. T 3000 has a molecular weight of about 3000) such as T 403 (approximately 5-6 PO groups per molecule), T 3000 (approximately 50 PO groups per molecule), T 5000 (approximately 85 PO groups per molecule);
JEFFAMINE® secondary amines (SD (secondary diamine) and ST (secondary triamine) series) such as SD 231 (based on the D 230 product), SD 401 (based on the D 400 product), SD 2001 (based on the D 2000 product), ST 404 (based on the T 403 product);

Polyether amines such as those available under the trade name SURFONAMINE® which have a polyether backbone based on PO, EO or a mixture of PO and EO units. Suitable amines from this range of products include:
SURFONAMINE® B Series amines (which are monoamines based on a PO or mixed PO/EO backbone structure) such as B 60 (EO/PO ratio 1/9 and molecular weight about 600), B 100 (PO backbone with a 9-carbon alkyl end group and molecular weight about 1000), B 200 (EO/PO ratio 9/29 and molecular weight about 2000);
SURFONAMINE® L series (which are monoamines with a mixed EO/PO backbone structure) such as L 100 (EO/PO ratio 19/3 and molecular weight about 1000), L 200 (EO/PO ratio 41/4 and molecular weight about 2000), L 207 (EO/PO ratio 33/10 and molecular weight about 2000), L 300 (EO/PO ratio 58/8 and molecular weight about 3000);
Of the SURFONAMINE® series of compounds, those in the L series are preferred where an increase in the hydrophilicity of the blocked isocyanate component is desired, whereas the B series are preferred where an increase in the hydrophobicity of the blocked isocyanate is desired;

Polyether amines available under the trade name ELASTAMINE® (having polyethylene glycol (PEG), polypropylene glycol(PPG), poly (tetramethylene ether glycol)(PTMEG), or a mixture of these groups in the compound backbone) such as RP-2009 (PPG backbone, molecular weight about 2000), RP-409 (PPG backbone, molecular weight about 400), RTP-2007 (PTMEG/PPG backbone, molecular weight about 2000), RTP-2005 (PTMEG/PPG backbone, molecular weight about 2000), RTP-1006 (PTMEG/PPG backbone, molecular weight about 1000), RTP-1407 (PTMEG/PPG backbone, molecular weight about 1400), RE-600 (PEG/PPG backbone, molecular weight about 600), RE-900 (PEG/PPG backbone, molecular weight about 900), RE-2000 (PEG/PPG backbone, molecular weight about 2000), ELASTAMINE® HE series (which are mixtures of di- and tri-amines in which the approximate molecular weight correlates to the product number, e.g. HE 1000 has a molecular weight of about 1000) HE-150 (PEG backbone, molecular weight about 150), HE-180 (PEG backbone, molecular weight about 180), HE-500 (PEG backbone, molecular weight about 500), HE-1000 (PEG backbone, molecular weight about 1000), HT-1700 (PTMEG backbone, molecular weight about 1700), HZ-200 (heterocyclic backbone, molecular weight about 200), and HP-2000 (PPG backbone, molecular weight about 2000).

Particularly preferred tolerance improving groups are selected from triethylene glycol diamine (TEGDA), JEFFAMINE® HK 511, ED 600, ED 900, HE 1000, ED 2003, monoethanolamine, diglycol amine, JEFFAMINE® M 1000 and M 2070. JEFFAMINE® ED 2003 is particularly preferred.

The blocked isocyanate (BI) is typically modified by mixing (optionally with a solvent) with the tolerance improving group and ageing at an elevated temperature before addition of other components of the wellbore fluid.

Preferably, the ageing takes place for between about 1 hour and about 2 days, although shorter times may be suitable for low levels of modification or particularly reactive tolerance improving groups and longer times may be required for high levels of modification or relatively unreactive tolerance improving groups. More preferably the ageing takes place for between about 1 hour and about 12 hours, or between about 1 hour and about 3 hours. Ageing time depends, at least in part, on the temperature used and nature of the blocking group. Ageing could be monitored using known analytical methods and the optimum ageing time could be ascertained by standard methods in the art.

Preferably the mixture of BI and tolerance improving group is aged at between about 60° C. (140° F.) and about 120° C. (248° F.), more preferably between about 70° C. (158° F.) and about 110° C. (230° F.), more preferably between about 75° C. (167° F.) and about 105° C. (221° F.), even more preferably about 80° C. (176° F.) [or 79.4° C., (175° F.)].

Polymeric Gels

In many cases the polymeric gels formed by crosslinking of the unblocked isocyanate are elastomeric. Elastomers are amorphous polymers existing above their glass transition temperature, so that considerable segmental motion is possible. At ambient temperatures, they are thus relatively soft and deformable. Such properties are derived from the structure of the compositions, long polymer chains crosslinked during curing. The elasticity is derived from the ability of the long chains to reconfigure themselves to distribute an applied stress, while the covalent crosslinkages ensure that the elastomer will return to its original configuration when the stress is removed.

Further, catalysts, accelerators, and/or retardants may optionally be added to effect or enhance gel formation. Also, additives such as viscosity enhancers, stabilizers, plasticizers, adhesion promoters, and fillers may be added to enhance or tailor the gel properties.

Viscosity Enhancers

In some embodiments, the compositions include a viscosity enhancer component. This additive may affect the hardness of the gel that forms when the blocked isocyanate reacts with the active hydrogen component to form a gel. Typically, the compositions of the present invention form a harder gel when a viscosity enhancer is included in the composition.

Suitable viscosity enhancers may include scleroglucan (a polysaccharide available under the trade name BIOVIS® from BASF Construction Polymers), xanthan gum, HEC (Hydroxyethyl cellulose), CMC (carboxymethyl cellulose), powdered silica (such as Aerosil 200), welan gum, diutan gum, guar gum, agar, carrageenan, gum Arabic, tragacanth gum, alginic acid, gellan gum, ghatti gum, locust bean gum, sodium alginate, mastic gum, beta-glucan, tara gum, chicle gum, glucomannan, dammar gum, karaya gum or a mixture of any two or more of these.

In preferred embodiments, the viscosity enhancer is powdered barite, scleroglucan (Biovis®), fumed silica, or a mixture of any two or more of these preferably scleroglucan and/or fumed silica.

In some embodiments, the viscosity enhancer component may also have the effect of altering the flow (rheological) properties of the composition and/or may also act as a filler.

Where the viscosity enhancer is scleroglucan (Biovis), the wellbore compositions described herein preferably include between about 0.5% w/v and about 5% w/v of the total wellbore fluid. More preferably, the scleroglucan is included at between about 0.5% w/v and about 2% w/v, even more preferably about 1-1.5% w/v of the total wellbore fluid.

Where the viscosity enhancer is fumed silica the composition preferably contains between about 0.5% and about 6% w/v fumed silica, more preferably between about 1.5% and about 4% w/v, even more preferably between about 2% and about 3.5% w/v silica.

In a most preferred embodiment, the wellbore fluid comprises about 1-1.5% w/v scleroglucan (Biovis) and about 2-3.5% w/v fumed silica (Aerosil) as viscosity enhancers.

Catalysts

In some embodiments, the elastomeric gel may be aided in its formation with the use of a catalyst. Suitable catalysts may include organometallic catalysts such as organic complexes of Sn, Ti, Pt, Pb, Sb, Zn, or Rh, inorganic oxides such as manganese (IV) oxide, calcium peroxide, or lead dioxide, and combinations thereof, metal oxide salts such as sodium perborates and other borate compounds, or organic hydroperoxides such as cumene hydroperoxide. In a particular embodiment, the organometallic catalyst may be dibutyltin dilaurate, a titanate/zinc acetate material, tin octoate, a carboxylic salt of Pb, Zn, Zr, or Sb, and combinations thereof.

Further, in forming polyisocyanurates, suitable catalysts may include Lewis bases, such as tertiary amines, phosphines, metal or quaternary ammonium salts of alkoxides or Lewis acid such as various organic metal compounds such as metal carboxylates.

The catalyst may be present in an amount effective to catalyze the curing of the liquid elastomer composition. In various embodiments, the catalyst may be used in an amount ranging from about 0.01 to about 10 weight percent, based on the total weight of the liquid elastomer(s), from about 0.05 to about 5 weight percent in other embodiments, and from about 0.1 to about 2 weight percent in yet other embodiments.

Additives

Additives are widely used in elastomer compositions to tailor the physical properties of the resultant polymeric gel. In some embodiments, additives may include plasticizers, thermal and light stabilizers, flame-retardants, fillers, adhesion promoters, or rheological additives. Accelerators and retardants may optionally be used to control the cure time of the elastomer. For example, an accelerator may be used to shorten the cure time while a retardant may be used to prolong the cure time. In some embodiments, the accelerator may include an amine, a sulfonamide, or a disulfide, and the retardant may include a stearate, an organic carbamate and salts thereof, a lactone, or a stearic acid.

Addition of plasticizers may reduce the modulus of the polymer at the use temperature by lowering its Tg. This may allow control of the viscosity and mechanical properties of the elastomeric gel. In some embodiments, the plasticizer may include phthalates, epoxides, aliphatic diesters, phosphates, sulfonamides, glycols, polyethers, trimellitates or chlorinated paraffin. In some embodiments, the plasticizer may be a diisooctyl phthalate, epoxidized soybean oil, di-2-ethylhexyl adipate, tricresyl phosphate, or trioctyl trimellitate.

Fillers are usually inert materials which may reinforce the elastomeric gel or serve as an extender. Fillers therefore affect gel processing, storage, and curing. Fillers may also affect the properties of the gel such as electrical and heat insulting properties, modulus, tensile or tear strength, abrasion resistance and fatigue strength. In some embodiments, the fillers may include carbonates, metal oxides, clays, mica, metal chromates, or carbon black. In some embodiments, the filler may include titanium dioxide, calcium carbonate, or non-acidic clays.

Addition of adhesion promoters may improve adhesion to various substrates. In some embodiments, adhesion promoters may include epoxy resins, modified phenolic resins, modified hydrocarbon resins, polysiloxanes, silanes, or primers. For example, addition of rheological additives may control the flow behaviour of the compound. In some embodiments, rheological additives may include fine particle size fillers, organic agents, or combinations of both. In some embodiments, rheological additives may include precipitated calcium carbonates, non-acidic clays, or modified castor oils.

Further, the incorporation of silanes may be also desirable. In some embodiments, silanes such as organosilanes and amino silanes may assist in the formation of the elastomeric gels in several ways, including, reaction with any unblocked isocyanates (either those that were originally unblocked or those that have become unblocked), which may slow reaction with an active hydrogen compound, increase bond strength and/or improve adhesion promotion.

Powdered barite has also been found to improve the stability of modified BI compositions and the gels formed on unblocking and crosslinking. Therefore, in some embodiments it is preferable to incorporate powdered barite into the wellbore fluid.

Gel Preparation

This section discusses the reaction of the blocked isocyanate with the active hydrogen compound to form a gel (as distinct from the modification of the BI with the tolerance improving group described above).

Aging Temperature

In various embodiments, the cure mechanism may be temperature dependent. Thus, some elastomers may preferentially cure at elevated temperatures such as about 60 to 100° C., while yet others may cure at higher temperatures such as 100-200° C. However, one of ordinary skill in the art would appreciate that, in various embodiments, the reaction temperature may determine the amount of time required for gel formation.

Time Required for Gel Formation

Embodiments of the gels disclosed herein may be formed by mixing an unblocked isocyanate with an active hydrogen compound, and optionally with a catalyst. In some embodiments, a gel may form immediately upon mixing the unblocked isocyanate and active hydrogen compound. In other embodiments; a gel may form within 1 minute of mixing; within 5 minutes of mixing in other embodiments; within 30 minutes of mixing in other embodiments. In some embodiments, a gel may form within 1 hour of mixing; within 8 hours in other embodiments; within 16 hours in other embodiments; within 80 hours in other embodiments; within 120 hours in yet other embodiments.

Gel Viscosity

In some embodiments, the wellbore fluid may initially have a viscosity similar to that of solvent, e.g., water. A water-like viscosity may allow the solution to effectively penetrate voids, small pores, and crevices, such as encountered in fine sands, coarse silts, and other formations. In other embodiments, the viscosity may be varied to obtain a desired degree of flow sufficient for decreasing the flow of water through or increasing the load-bearing capacity of a formation. The viscosity of the fluid may be varied by increasing or decreasing the amount of solvent relative to other components, by employing viscosifying agents, altering the amount or nature of the tolerance improving group (discussed above) or by other techniques common in the art.

In some embodiments, the solvent may represent up to about 90 weight percent of the composition, preferably up to about 50 weight percent of the composition, more preferably up to about 30 weight percent of the composition.

Gel Hardness

The reaction of the isocyanate and active hydrogen compound may produce gels having a consistency ranging from a viscous sludge to a hard gel. In some embodiments, the reaction of the isocyanate and active hydrogen compound may result in a soft elastic gel. In other embodiments, the reaction may result in a firm gel and in a hard gel in yet other embodiments. The hardness of the gel is the force necessary to break the gel structure, which may be quantified by measuring the force required for a cylindrical shaped test probe to penetrate the crosslinked structure. Hardness is a measure of the ability of the gel to resist to an established degree the penetration of a weighted test probe.

Hardness may be measured by using a Brookfield QTS-25 Texture Analysis Instrument. This instrument consists of a probe of changeable design that is connected to a load cell. The probe may be driven into a test sample at specific speeds or loads to measure the following parameters or properties of a sample: springiness, adhesiveness, curing, breaking strength, fracturability, peel strength, hardness, cohesiveness, relaxation, recovery, tensile strength burst point, and spreadability. The hardness may be measured by driving a 4 mm diameter, cylindrical, flat faced probe into the gel sample at a constant speed of 30 mm per minute. When the probe is in contact with the gel, a force is applied to the probe due to the resistance of the gel structure until it fails, which is recorded via the load cell and computer software. As the probe travels through the sample, the force on the probe and the depth of penetration are measured. The force on the probe may be recorded at various depths of penetration, such as 20, 25, and 30 mm, providing an indication of the gel's overall hardness. In some embodiments, the resulting gel may have a hardness value from 10 to 100000 gram-force. In other embodiments, the resulting gel may be a soft elastic gel having a hardness value in the range from 10 to 100 gram-force. In other embodiments, the resulting gel may be a firm gel having a hardness value from 100 to 500 gram-force. In other embodiments, the resulting gel may range from hard to tough, having a hardness value from 500 to 100000 gram-force; from 1500 to 75000 gram-force in other embodiments; from 2500 to 50000 gram-force in yet other embodiments; from 5000 to 30000 gram-force in yet other embodiments.

In other embodiments, the hardness of the gel may vary with the depth of penetration. For example, the gel may have a hardness of 1500 gram-force or greater at a penetration depth of 20 mm in some embodiments. In other embodiments, the gel may have a hardness of 5000 gram-force or greater at a penetration depth of 20 mm; 15,000 gram-force or greater at a penetration depth of 20 mm in other embodiments; and 25000 gram-force or greater at a penetration depth of 25 mm in yet other embodiments.

A “gel” may be described as a composition having a hardness of about 50 gram-force or above as measured by the method described above.

With respect to the variables listed above (i.e. temperature, time, etc.), those having ordinary skill in light of the disclosure will appreciate that, by using the present disclosure as a guide, properties may be tailored as desired.

Polymer Processing

Some embodiments of the polymeric gels disclosed herein may be formed in a single component system, where the blocked isocyanate and active hydrogen compound, and optionally catalysts, additives, accelerators or retarders are premixed and may be placed or injected prior to curing. The gel times may be adjusted by the use of retarders or accelerators, or by the selection of a more or less reactive active hydrogen compound. Other embodiments of the gels disclosed herein may also be formed in a two-component system, where the components may be mixed separately and combined immediately prior to injection. Alternatively, one reagent, the blocked isocyanate or active hydrogen compound, may be placed in the wellbore or the near-wellbore region where it may then be contacted by the other reagent, either the isocyanate or active hydrogen compound as required.

Applications

Embodiments of the gels and wellbore fluids disclosed herein may be used in applications including: as an additive in drilling muds; as an additive for enhancing oil recovery (EOR); as one additive in loss circulation material (LCM) pills; wellbore (WB) strengthening treatments; soil stabilization; as a dust suppressant; as a water retainer or a soil conditioner; as hydrotreating (HT) fluid loss additives, and others.

Use in Drilling Muds

Drilling fluids or muds typically include a base fluid (for example water, diesel or mineral oil, or a synthetic compound), weighting agents (for example, barium sulfate or barite may be used), bentonite clay, and various additives that serve specific functions, such as polymers, corrosion inhibitors, emulsifiers, and lubricants. Those having ordinary skill in the art will recognize that a number of different muds exist, and limitations on the present invention is not intended by reference to particular types. During drilling, the mud is injected through the centre of the drill string to the drill bit and exits in the annulus between the drill string and the wellbore, fulfilling, in this manner, the cooling and lubrication of the bit, casing of the well, and transporting the drill cuttings to the surface. The gels and wellbore fluids disclosed herein may be used as an additive in drilling mud. In some embodiments, the gels may form a filter cake or one component of a filter cake that forms along the wellbore as drilling progresses. The gels contained in the drilling fluid may be deposited along the wellbore throughout the drilling process, potentially strengthening the wellbore by stabilizing shale formations and other sections encountered while drilling. Improved wellbore stability may reduce the occurrence of stuck pipe, hole collapse, hole enlargement, lost circulation, and may improve well control.

Wellbore stability may also be enhanced by the injection of a low viscosity mixture of gel precursors into formations along the wellbore. The mixture may then continue to react, strengthening the formation along the wellbore upon gelation of the mixture.

In other embodiments, the gels disclosed herein may aid in lifting solid debris from tubing walls and through the tubing annulus. Hard gels circulating through the drill pipe during drilling may scrape and clean the drill pipe, removing any pipe scale, mud, clay, or other agglomerations that may have adhered to the drill pipe or drill tubing. In this manner, the drill pipe may be maintained free of obstructions that could otherwise hinder removal of drilled solids from the drill pipe during drilling.

Advantages of the present disclosure may include a polymeric gel composition with excellent ability to vary the gel properties based on a variety of applications. Such polymers display an exceptionally wide range of chemistries and physical properties. As such, the polymer precursors and resulting polymer may be selected to tailor the properties of the resultant polymeric gel. Adjustable gelation times, temperatures, and physical properties of the resulting gel may be selected for a particular desired application, and in particular embodiments, gels may form at lower temperatures than typically observed for blocked isocyanates. For example, the polymeric gel may be chosen to an appropriate hardness, or flexural or elastic modulus. Additionally, polymer-based systems tend to be flexible, impact resistant, exhibit exceptional bond strength and low toxicity and volatility. Further, by using blocked isocyanates modified with a tolerance improving group, a delayed gelation may occur so as to allow for sufficient time for the reactants to permeate into the formation prior to gelation.

The use of blocked isocyanates that have one or more tolerance improving groups bonded to them results in gels and wellbore fluids that exhibit an increased tolerance to contaminants (such as seawater, calcium chloride brine, calcium bromide brine, sodium chloride brine, potassium chloride brine, magnesium ion brines, cement slurry, potassium formate brines and naturally occurring contaminants from salt domes being drilled) compared to unmodified blocked isocyanate gels.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### EXAMPLES

Two blocked isocyanates (BIs), one from Lamberti SpA (Gallarate (VA), Italy), the other from Baxenden Chemicals Limited (Accrington, England), were used as the basis for investigations into various gel compositions.

TABLE 1
Supplier's Description of BI Dispersions

| | LDP 437 | Trixene 7987 |
|---|---|---|
| Supplier | Lamberti | Baxenden |
| % Actives | 30 | 40 |
| Backbone | TDI | HDI Trimer |
| Blocking agent | MEKO | DMP |
| % NCO | 6.5 | 4.5 |
| Equivalent weight | 646 | 933 |
| (on 100% active | | |
| basis) | | |
| Co-solvent | NMP | DPGME |

Note
NMP = n-methyl pyrrolidone
DPGME = dipropylene glycol methyl ether
TDI = Toluene diisocyanate
HDI = Hexamethylene diisocyanate
MEKO = Methyl ethyl ketoxime
DMP = 3,5-dimethyl pyrazole

### Example 1

### Formulation of Trixene 7987 and LDP 437 Compositions with XC Viscosifier

Compositions were prepared as given in table 2.

TABLE 2
XC compositions in % w/v

| Composition | Trixene 7987 | Composition | LDP 437 |
|---|---|---|---|
| Trixene 7987 | 59 | LDP 437 | 99 |
| Water | 40.5 | Water | 0 |
| XC | 0.5 | XC | 1.0 |
| % Actives | 23% | % Actives | 30% |

Note -
XC = xanthan gum
The higher XC conc. in LDP 437 base made it quite viscous and so was reduced for the Trixene 7987 tests

### Example 2

### Formulation of Trixene 7987 and LDP 437 with HEC and Biovis Viscosifiers

From the tests with xanthan gum (XC) described in Example 1, other types of viscosifier were tested in combination with the BI emulsions to ensure the trends being observed hold true when the formulation is varied. The viscosifiers evaluated were BIOVIS, a scleroglucan gum and HEC (Hydroxyethyl cellulose), both selected for their rheological and/or protective colloid characteristics. The formulations used are given in table 3.

TABLE 3
BIOVIS or HEC Bases Formulations in % w/v

| Composition | Trixene 7987 | Composition | LDP 437 |
|---|---|---|---|
| Trix. 7987 | 59 | LDP 437 | 99 |
| Water | 40 | Water | 0 |
| BIOVIS or HEC | 1 | BIOVIS or HEC | 1 |
| % Actives | 23% | % Actives | 30% |

Note -
The pH was adjusted to ~8.3 with a few drops of 5N caustic solution (NaOH) after the addition of the viscosifier to initiate full hydration of the polymer.

### Example 3

### Testing of Trixene 7987 and LDP 437 Compositions for Gelation with Amines

10 ml samples of the compositions from Examples 1 and 2 were mixed with varying levels of different types of hydrophilic amine and then aged at 170° F. In these tests, Jeffamine HE 1000 and ED 2003 were used as 80% aqueous solutions.

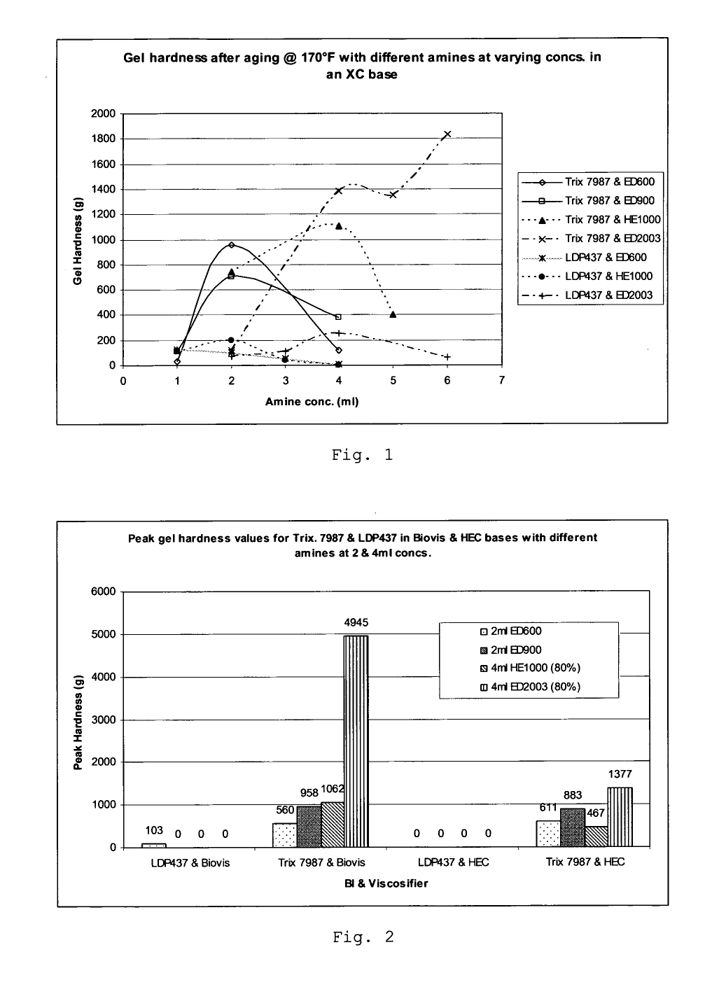

After aging the samples were tested on the QTS texture analyser using a 4 mm diameter probe at a rate of 20 mm/min penetration. Under these conditions 1 g force approximates to 0.1 psi hardness. The main class of amines tested were water soluble polyether diamines, with the commercial name Jeffamine supplied by Huntsman. The ED series are based predominantly on a PEG CEO) backbone with PO end caps, with an indication of the molecular weight given by the product code number. Elastamine HE 1000 is slightly different and is described as being a mixture of di & tri amine based on a PEG CEO) backbone with a molecular weight of ˜1000. As it is based on EO it was expected to have even more hydrophilic characteristics than the ED series. The results presented in FIG. 1 and are a summary of hardness values obtained with the best performing amines for the compositions of Example 1. The compositions from Example 2 were tested in the same way and the results are shown in FIG. 2.

Some other types of amine, such as polyethylene imines, were tested but these typically caused coagulation of the composition or did not gel at all.

The results in FIG. 1 show that in an XC base Trixene 7987 gives harder gels than the LDP 437 with the different amines tested at the various levels. Furthermore, the data indicates that as the molecular weight of the amine increases so does the hardness, with the strongest gels being seen with ED2003 having a hardness of nearly 2000 g. As may be anticipated from theory the optimal amine dose ranges are less for the lower molecular weight amines at around 2 ml (per 10 ml of the blocked isocyanate composition) and higher (around 4 ml per 10 ml BI composition) for the larger molecules due to the number of functional amine groups present.

Looking at the results in FIG. 1 in more detail it is surprising that Trixene 7987 gives stronger gels than LDP 437 as it has been diluted in the base formulation to an actives content of 23%, whereas the LDP 437 is at 30%. This means that the LDP 437 formulations have a higher polymer content than the Trixene gels and therefore may be expected to be stronger. In addition, the XC content of the LDP 437 composition is higher than in the Trixene composition, which again, in theory, might be expected to mean that it produces a stronger gel, however it does not. Also, the results indicate that the maximum strengths have been reached at the LDP 437/amine ratios used so lack of amine can be discounted as a reason for the weaker gels with LDP 437 compositions.

As mentioned above, tests were carried out with other viscosifiers, first to see if they have an effect on gel strength and secondly, to see if this effect is directly related to the type of BI emulsion used and to ensure the trends being observed are valid in broader terms. Scleroglucan and HEC bases were used to test the BI compositions further.

The results in FIG. 2 highlight the same main trends seen in FIG. 1 where Trixene gives the hardest gel with various amines and the strongest ones with ED2003. Using LDP 437 with HEC or Biovis (scleroglucan) typically did not form gels that were suitable for testing.

This also demonstrates that the type of viscosifier used in the composition has an effect on gel strength. It can be seen by comparing the results in FIGS. 1 & 2 that using Biovis (scleroglucan) in the Trixene base increases the hardness to nearly 5000 g which is 2.5 times harder than the corresponding sample with XC. On the other hand, HEC appears to produce weaker gels than XC. This could be attributed to the different chemical structures of HEC, XC, and scleroglucan, where scleroglucan has the least temperature dependant viscosity profile which may help to suspend the gel more effectively as it is forming, also its chemical structure may mean that it takes part in the cross linking reaction. Therefore the viscosifier can play an important role when formulating these gels.

### Example 4

### Optimisation Tests Focusing on Trixene 7987 & Jeffamine ED2003

The compositions given in table 4, were prepared with varying levels of 80% aq. ED2003 (XTJ502). API barite and fine calcium carbonate solids were also added to check their compatibility in the system. The densities of the fluids with the added of solids have been calculated and are given in table 5.

TABLE 4
Base Formulations in % w/v for Optimisation Tests

| | Composition | | |
|---|---|---|---|
| Material | A | B | C |
| Trixene 7987 | 60% | 60% | 60% |
| Biovis | 1% | — | — |
| XC | — | 0.50% | — |
| PAC Reg | — | — | 1% |
| Water | Remainder | | |
| Comment | pH adjusted | pH not | pH not |
| | to 8 to help | adjusted | adjusted |
| | Biovis yield | | |

Notes -
PAC = Polyanionic cellulose (oilfield term for CMC).
Both PAC and XC yield OK in the fluid without pH adjustment; however they were possibly a bit too viscous
Trixene 7987 is 40% active; so 40% dilution = 24% BI actives in sample ~2.4 g in 10 ml

TABLE 5
Calculated densities of gel formulations with added solids

| Liquids | | Solids | | | Totals | | Density | |
|---|---|---|---|---|---|---|---|---|
| Mass | Vol. | Material | Mass | Vol. | Mass | Vol. | SG | PPG |
| 14 | 14 | Barite | 10 | 2.33 | 24 | 16.33 | 1.47 | 12.25 |
| 14 | 14 | Barite | 15 | 3.49 | 29 | 17.49 | 1.66 | 13.81 |
| 14 | 14 | Barite | 20 | 4.65 | 34 | 18.65 | 1.82 | 15.19 |
| 14 | 14 | CaCO3 | 5 | 1.85 | 19 | 15.85 | 1.20 | 9.98 |
| 14 | 14 | CaCO3 | 10 | 3.70 | 24 | 17.70 | 1.36 | 11.29 |
| 14 | 14 | CaCO3 | 15 | 5.56 | 29 | 19.56 | 1.48 | 12.35 |

Note -
SG = Specific Gravity

TABLE 6
Optimisation Test Results Focusing on Trixene 7987 & ED2003

| | | | | | Observations | Peak |
|---|---|---|---|---|---|---|
| | | | | Initial | overnight @ | Hardness |
| Sample | Compⁿ | Amine | Addition | Observations | 170° F. | (g) |
| | A (biovis) | ED2003 (80%) | | | | |
| 1 | 10 | 3 | | | Higher modulus/ | 814 |
| 2 | 10 | 4 | | | stiffer gels with | 902 |
| 3 | 10 | 5 | | | increased amine | 1445 |
| 4 | 10 | 6 | | | | 2208 |
| 5 | 10 | 7 | | | | 2047 |
| | B (XC) | ED2003 (80%) | | | | |
| 6 | 10 | 5 | | | | 821 |
| 7 | 10 | 6 | | | | 1447 |
| 8 | 10 | 7 | | | | 1233 |
| | C (PAC reg) | ED2003 (80%) | | | | |
| 9 | 10 | 5 | | | | 499 |
| 10 | 10 | 6 | | | | 612 |
| 11 | 10 | 7 | | | | 655 |
| | A (biovis) | ED2003 (80%) | API barite | | | |
| 12 | 10 | 4 | 10 | | 15% separation | 2575 |
| 13 | 10 | 4 | 15 | | | 2349 |
| 14 | 10 | 4 | 20 | | | 1837 |
| | | | Fine CaCO3 | | | |
| 15 | 10 | 4 | 5 | | 10% separation | 3116 |
| 16 | 10 | 4 | 10 | | | 2246 |
| 17 | 10 | 4 | 15 | A bit viscous but | | 2556 |
| | | | | ok on rolling | | |
| | A (biovis, pH | ED2003 (80%) | | | | |
| | Adjusted 8.5 | | | | | |
| | for more yield) | | | | | |
| 18 | 10 | 3 | | pH after | | 3868 |
| | | | | amine = 10 | | |
| 19 | 10 | 4 | | pH after | | 4028 |
| | | | | amine = 10.2 | | |
| 20 | 10 | 5 | | pH after | | 3021 |
| | | | | amine = 10.3 | | |

Note -
Amounts of liquids are listed in ml and of solids are listed in g.

The results in table 6 are broadly in agreement with the earlier results seen in Examples 1-3. Again, scleroglucan gum (BIOVIS) was seen to give higher hardness values than XC and another potential alternative protective colloid/viscosifier screened alongside it often referred to as PAC regular, or more widely in general industry as CMC. The first test series, samples 1-5, show that the optimal level of amine appears to be around 6 ml per 10 ml of blocked isocyanate base composition. However, these gels were weaker than those seen before with BIOVIS, so consequently they were repeated, ensuring the polymer was fully hydrated this time. This action had the effect of improving the hardness to the expected levels as shown by samples 18-20. This indicates that care needs to be taken to ensure that the mixing process is sufficiently vigorous to obtain consistent results.

The effect of adding solids to the formulation can be seen from samples 12-17. These show that the use of either barite or calcium carbonate solids can increase the gel strength (e.g. 902 g—sample 2) 2 to 3 times. The suspension of the solids appeared to be fairly homogeneous at the highest densities of 15.2 and 12.4 ppg for barite and carbonate respectively. At the lowest densities of 12.3 and 10 ppg respectively some minor settlement and 10-15% of clear gel was observed at the top of the vials. Nevertheless, these results suggest that the main components of the compositions are compatible with solids.

### Example 5

### Stability Testing of the Trixene 7987 & Jeffamine ED2003 System

10 ml of composition A as given in table 4 above, was combined with 4 ml of 80% ED2003 and tested for compatibility with simulated cement, seawater, and potassium chloride and calcium chloride brine contamination as outlined in table 7 below. Tests were also carried out in the presence of barite solids.

TABLE 7
Stability Test Results on the Trixene 7987 & ED2003 System

| | | | | | Observation | |
|---|---|---|---|---|---|---|
| | | | % | Initial | overnight @ | Hardness |
| Sample | Addition | Contam. | Contam | Observation | 170° F. | (g) |
| 21 | | | | | OK | 2452 |
| | | | | | homogeneous | |
| | | | | | gel | |
| 22 | | 1 ml SW | 7% | | OK | 2218 |
| | | | | | homogeneous | |
| | | | | | gel | |
| 23 | | 1 ml CaCl2 | 7% | | ppt & | NSFT |
| | | (20%) | | | liquid | |
| 24 | | 1 ml Cement | 7% | | OK | 2232 |
| | | Slurry | | | homogeneous | |
| | | (20%) | | | gel | |
| | Barite | | | | | |
| 25 | 15 | | | | OK | 2677 |
| | | | | | homogeneous | |
| | | | | | gel | |
| 26 | 15 | 1 ml SW | 6% | | OK | 1553 |
| | | | | | homogeneous | |
| | | | | | gel | |
| 27 | 15 | 1 ml CaCl2 | 6% | Instant | 20% free | NSFT |
| | | (20%) | | Coagulation | liq & paste | |
| 28 | 15 | 1 ml Cement | 6% | | 5% | 1847 |
| | | Slurry | | | settlement | |
| | | (20%) | | | | |
| 29 | 15 | 1 ml KCl | 6% | Some ppt | 20% Free | 2484 |
| | | (8%) | | | liq & Gel | |

Note:
NSFT = Gel Not Suitable for Testing
SW = Seawater

The test results in table 7 show that both the un-weighted (without barite) or weighted (with barite) fluids have reasonable stability towards seawater and cement contamination. However, the tolerance to calcium chloride and potassium chloride brines was relatively poor. This may be due to Trixene 7987 being anionically stabilised.

### Example 6

### Tests to Try and Improve the Calcium Chloride Tolerance of the Trixene 7987 & Jeffamine ED2003 System Utilising External Mechanisms

Tests were concurrently carried out to see if the potassium and calcium brine contamination issues could be overcome simply.

Tests were performed to see if external stabilisation (adding supplementary protective colloids, surfactants etc. to the compositions) could be used to improve the tolerance to brine contamination.

Tests were performed as outlined in table 8, where again 4 ml of 80% ED2003 was added to 10 ml of composition A (60% Trixene 7987) from table 4. The compositions in table 8 contain different types of external stabilisers. As indicated in the table tests were carried out in a series of three; the benchmark with the stabiliser, followed by samples with simulated KCl and Calcium Chloride contamination.

A large number of tests were carried out looking at various classes of stabilisers, however most were ineffective. This is because, on contamination with calcium chloride brine, all of the samples went through a stage where the fluid resembled cottage cheese, i.e. it coagulated on addition of the brine contaminant. In addition the subsequent gel hardness values, after aging, were much weaker than the unmodified composition (i.e. composition A from table 4 without any contamination).

Various types of surfactant were evaluated as external stabilisers and the highlights are described in tables 9 and 10. Most surfactants were screened at 1 and 3% based on the total volume of gel fluid.

TABLE 8
Evaluation of External Stabilisers in the Trixene 7987 & ED2003 System

| | | | | | Observations | Peak |
|---|---|---|---|---|---|---|
| | | | % | Initial | overnight @ | Hardness |
| Sample | Addition | Contam | Contam | Obs. | 170° F. | (g) |
| | Softanol | | | | | |
| | 120 | | | | | |
| 30 | 1% | | | | OK | 1773 |
| | | | | | homogeneous | |
| | | | | | gel | |
| 31 | 1% | 1 ml KCl | 7% | | OK | 1439 |
| | | (8%) | | | homogeneous | |
| | | | | | gel | |
| 32 | 1% | 1ml CaCl2 | 7% | Instant | liquid & | 210 |
| | | (10%) | | ppt | swollen | |
| | | | | | granules | |
| | SAS93 | | | | | |
| 33 | 1% | | | | OK | 1334 |
| | | | | | homogeneous | |
| | | | | | gel | |
| 34 | 1% | 1 ml KCl | 7% | | OK | 1274 |
| | | (8%) | | | homogeneous | |
| | | | | | gel | |
| 35 | 1% | 1 ml CaCl2 | 7% | Instant | liquid & | 680 |
| | | (10%) | | ppt | swollen | |
| | | | | | granules | |

TABLE 9
Highlights of stability testing of the Trixene 7987
& ED2003 System using the 5% Aerosil 200 composition
(hydrophilic amorphous fumed silica) Unweighted

| | | | Initial | Observations | |
|---|---|---|---|---|---|
| Sam- | | % | Observa- | overnight @ | Hard- |
| ple | Contam. | Contam. | tions | 170° F. | ness (g) |
| 37 | | | clearish liq | homogeneous | O/S @ |
| | | | | gel | 14 mm |
| 38 | 1 ml | 7% | clearish liq | Spongey | 1564 |
| | KCl (8%) | | | homog gel | |
| 39 | 1 ml | 7% | Inst ppt & | Spongey | 1018 |
| | CaCl2 (10%) | | lump | homog gel | |

Note -
O/S = Off Scale at a certain depth of penetration i.e. >5000 g or 500 psi force on probe

TABLE 10
Highlights of stability testing of the Trixene 7987 & ED2003 System using 5% Aerosil
200 composition (hydrophilic, amorphous, fumed silica) Weighted (barite)

| | | | | | | | Biovis (composition A, | |
|---|---|---|---|---|---|---|---|---|
| | | | | | | | table 4) results for | |
| | | | | | Observations | | comparision | |
| | Addition | | | Initial | overnight @ | Hardness | Obs overnight @ | Hardness |
| Sample | Barite | Contam | % Contam | Observations | 170° F. | (g) | 170° F. | (g) |
| 40 | 15 | | | Low viscosity liq | OK | 4135 | OK | 2677 |
| | | | | for 1+ hrs | homogeneous | | homogeneous | |
| | | | | | gel | | gel | |
| 41 | 15 | 1 ml SW | 6% | Low viscosity liq | OK | 4798 | OK | 1553 |
| | | | | for 1+ hrs | homogeneous | | homogeneous | |
| | | | | | gel | | gel | |
| 42 | 15 | 1 ml CaCl2 | 6% | Instant | OK | 1350 | 20% free | *NSFT |
| | | (10%) | | Coagulation | homogeneous | | liq & paste | |
| | | | | | gel | | | |
| 43 | 15 | 1 ml Cement | 6% | Samples turn | OK | 4918 | 5% settlement | 1847 |
| | | Slurry | | quickly viscous | homogeneous | | | |
| | | (10%) | | on rolling but do | gel | | | |
| 44 | 15 | 1 ml KCl | 6% | not set - remain | OK | 3198 | 20% Free | 2484 |
| | | (8%) | | as paste | homogeneous | | liq & Gel | |
| | | | | | gel | | | |

Note -
*20% Calcium Chloride brine used with scleroglucan not 10%

The results in tables 9 and 10 describe highlights of the investigation of a comprehensive range of potential external stabilisers either alone or in combinations to try and improve the stability of the system towards brine, albeit with limited success.

The most promising results were seen with the use of hydrophilic fumed silica (Aerosil 200) as shown in tables 9 & 10. It can be seen from these results that it produces harder gels that are more tolerant to contaminants than the corresponding scleroglucan viscosified gels. It should also be noted that the addition of barite solids seems to further enhance the stability of the system toward these contaminations.

### Example 7

### Tests to Improve the Brine Tolerance of the Trixene 7987 & Jeffamine ED2003 System Utilising Internal Stabilisation Mechanisms

The results of this work showed that increased electrolyte stability could be achieved via internal stabilisation methods (i.e. covalently bonding hydrophilic anionic, cationic and/or non-ionic functionalities into the structure of the Trixene 7987).

The first attempts at modifying Trixene 7987 are given in table 11 and were performed using the following hydrophilic diamines: TEGDA=tri ethylene glycol diamine; HK 511=2£011.2 PO diamine ˜200 Mw; ED series=EO/PO diamines with increasing Mw as indicated by the subsequent code number; HE1000=All EO di & tri amine mixture ˜1000 Mw.

Low levels of the hydrophilic amine were added to base and dynamically aged for lhr at 175° F. to react the amine with the BI. It was noted that the samples with lower molecular weight (Mw) amines became quite viscous. The samples were then left overnight at room temperature. When Amine 80% ED2003 (20% water) was added to the samples in the morning they went thin especially those modified with the higher Mw amine samples. Samples with low Mw amines in them remained as emulsions, whereas samples containing the higher Mw amines went clear. It should be noted that only 3 ml of 80% ED2003 (20% water) (XTJ 502) was added to form the gel to take into account the amine tolerance improving using up some of the reactive isocyanate groups.

TABLE 11
Internal Stabilisation of Trixene 7987 & ED2003 System using hydrophilic diamines

| | | | crosslink | | | | |
|---|---|---|---|---|---|---|---|
| | | Mod. | Amine | | | | |
| | Composition | Amine | ED2003 | | Initial | Observations. | Hardness |
| Sample | A - table 4 | TEGDA | (80%) | Contaminant. | Observations | 16 hrs @ 170° F. | (g) |
| 45 | 10 | 0.25 | 3 | | No coagulation | All samples | 277 |
| 46 | 10 | 0.5 | 3 | 1 ml CaCl2 | on addition of | with brine in | NSFT |
| | | | | (10%) | brine although | have separated | |
| | | HK511 | | | emulsion does | with gel plug | |
| 47 | 10 | 0.25 | 3 | | eventually start | at bottom. | 1202 |
| 48 | 10 | 0.5 | 3 | 1 ml CaCl2 | to coagulate | Higher Mw | NSFT |
| | | | | (10%) | No coagulation | amines give | |
| | | ED600 | | | on addition of | less free | |
| 49 | 10 | 0.25 | 3 | | brine although | liquid | 1965 |
| 50 | 10 | 0.5 | 3 | 1 ml CaCl2 | emulsion does | All samples | NSFT |
| | | | | (10%) | eventually start | with brine in | |
| | | ED900 | | | to coagulate | have separated | |
| 51 | 10 | 0.25 | 3 | | | with gel plug | 2039 |
| 52 | 10 | 0.5 | 3 | 1 ml CaCl2 | | at bottom. | NSFT |
| | | | | (10%) | | Higher Mw | |
| | | HE1000 | | | | amines give | |
| 53 | 10 | 0.25 | 3 | | | less free | 1791 |
| 54 | 10 | 0.5 | 3 | 1 ml CaCl2 | | liquid | NSFT |
| | | | | (10%) | | | |
| | | ED2003 | | | | | |
| 55 | 10 | 0.25 | 3 | | | | 2410 |
| 56 | 10 | 0.5 | 3 | 1 ml CaCl2 | | | NSFT |
| | | | | (10%) | | | |

Note:
1 ml CaCl₂ is approximately equivalent to a level of 7% simulated brine contamination

In the second series presented in table 12, small hydrophilic, monoamines, were reacted and tested in a similar way to the diamines in table 11 to compare performance. It was felt that the increase in Mw caused by reaction with the diamine could offset the advantages of making the molecule more hydrophilic. The monoamines tested were mono ethanolamine and diglycol amine (DGA). With the addition of these compounds it was found that the aging temperature had to be increased from 170 to 200° F. to get the samples to form gels.

TABLE 12
Internal Stabilisation testing of Trixene 7987 & ED2003
System using hydrophilic low molecular weight monoamines

| | Composition | Mod | crosslink | | | Observations @ | |
|---|---|---|---|---|---|---|---|
| | 60% Trixene + | Amine | Amine | | Initial | 170° F. & | Hardness |
| Sample | 1% BIOVIS | PTS 100 | 80% ED2003 | Contaminant | Observations | 200° F. | (g) |
| 57 | 10 | 0.25 | 3 | | Samples don't | gel | 590 |
| | | DGA | | | gel at 75° C. | | |
| 58 | 10 | 0.25 | 3 | | Temp inc. to | gel | 880 |
| | | | | | 95° C. | | |
| | | PTS 100 | | | | | |
| 59 | 10 | 0.25 | 3 | 1 ml CaCl2 | Does not | | NSFT |
| | | DGA | | (10%) | coagulate but | | |
| 60 | 10 | 0.25 | 3 | 1 ml CaCl2 | gel collapses | | NSFT |
| | | | | (10%) | | | |

The third series of results displayed in table 13 are very similar to the tests conducted with the small monoamines and demonstrate the effects of grafting higher Mw monoamines onto the BI polymer. Again, the base was modified by heat aging Trixene 7987 (diluted by 40% water) with the modifying amine for an extended period at 175° F. The amines used in these tests were as follows: Jeffamine M1000=19 EO/3 PO mono amine and Jeffamine M2070=31 EO/10 PO mono amine.

TABLE 13
Highlights of Internal Stabilisation testing of the Trixene 7987 & ED2003
Prototype System using hydrophilic high molecular weight monoamines

| | | | Crosslink | | | | |
|---|---|---|---|---|---|---|---|
| | Base | Mod | Amine | | | | |
| | 60% Trixene + | Amine | 80% | | Initial | Observations @ | Hardness |
| Sample | 1% BIOVIS | M1000 | ED2003 | Contaminant | Observations | 170° F. | (g) |
| 61 | 10 | 0.5 | 3 | | | homogeneous gel | 3789 |
| | | M2070 | | | | | |
| 62 | 10 | 0.5 | 3 | | | homogeneous gel | 2570 |
| | | M1000 | | | | | |
| 63 | 10 | 0.5 | 3 | 1 ml CaCl2 | Does not form | homogeneous gel | 448 |
| | | | | (10%) | cottage cheese | | |
| | | M2070 | | | & gel does not | | |
| 64 | 10 | 0.5 | 3 | 1 ml CaCl2 | collapse | homogeneous gel | 528 |
| | | | | (10%) | | | |

The results presented in table 11 are of interest because even though the samples containing the brine eventually did collapse there were some indications that in the initial stages the samples were more stable than the earlier attempts at external stabilisation. For example, on addition of the brine the polymer did not instantly coagulate out of solution and look like something akin to cottage cheese. In addition, it was noted that the higher Mw materials appeared to give less free liquid than the smaller molecules. This is probably due to a lower crosslink density; nevertheless this observation first generated the concept of weighing the free liquid in order to give a relative assessment of how much the gel had collapsed.

The results in table 12 show that a range of materials have been considered and tested. Again, the samples containing brine did not coagulate initially, although the gels did still eventually collapse. Additionally, it was significant to see that the low Mw monoamines dramatically retarded the set time of the gel. This is interesting because it strongly supports the idea that the amine is actually reacting with the BI i.e. the BI base polymer is actually being modified. This result fits the theory that the relatively high proportion of amine groups on the small molecules are reacting with the iscocyanate groups on the BI polymer which reduces the crosslink density when the gels are formed making the gels much softer and also increasing the time it takes to “build” molecular weight as evidenced by the fact the temperature had to be raised to 200° F. in order for them to gel. This provides another potential method that could be exploited to extend the temperature range at which the system can function.

The data in table 13 demonstrates the effects of modifying the BI polymer with high Mw amine as compared to the low Mw amines tested in table 12. It can be seen that the samples neither coagulated nor did the gels collapse. The control samples without any brine showed good hardness. This is probably due to the monoamines having high Mw and so having a lower proportion of amine groups on them, with the consequence that the crosslink density on gel formation is not reduced too much. Molecular entanglement of the large pendant groups may also be a factor as to why the samples still remain hard. Although the hardness of the gels formed from brine-containing samples is slightly lower than from the uncontaminated compositions, they are nevertheless homogeneous gels. From these results it can be seen that grafting high molecular weight hydrophilic pendant groups onto the BI polymer is a useful method to increase electrolyte tolerance.

### Example 8

### Tests to Optimise the Internal Stabilisation Mechanisms in the Trixene 7987 & Jeffamine ED2003 System

10 ml of the 60% Trixene 7987 base contains ˜2.3 g polymer so the addition 0.5 ml monoamine=0.5/(2.3+0.5) is approximately equivalent to ˜18% modification.

Tests were performed to try and understand the effects of varying the levels of the modifying amine and cross linking amine on the gel properties. The formulations used are given in table 14.

TABLE 14
Formulations used to evaluate the effects on gel properties
of varying modifying and cross linking amines

Composition

| Material | D | E |
|---|---|---|
| Trixene 7987 | 60 | 60 |
| (ml) | | |
| Water (ml) | 40 | 40 |
| Jeffamine | Varied - 0.5, 1, 2, | |
| M1000 (ml) | 4, 5, 7 (Reported | |
| | as ~% levels) | |
| Jeffamine | | Varied - 0.5, 1, 2, |
| M2070 (ml) | | 4, 5, 7 (Reported |
| | | as ~% levels) |
| Biovis (g) | 1 (Reported as ~1%) | 1 (Reported as ~1%) |

The general modification procedure employed was to mix the Trixene 7987 with the monoamine at an elevated temperature, typically 170° F., for a period of at least 2.5 hrs, in order to give them time to react. Once the components had reacted sufficiently Biovis (1%) was added and the pH adjusted to 8.5 (with 5N NaOH) if necessary to fully hydrate and yield the polymer. As with the previous test data presented herein, the results are for 10 ml of the composition placed in a vial to which the additions were made. The modified compositions are summarised in table 15.

TABLE 15
Formulations used to evaluate the effects on gel properties
of varying modifying and crosslinking amines

Composition

| Material | F | G |
|---|---|---|
| Trixene 7987 | 30 | 30 |
| (ml) | | |
| Water (ml) | 20 | 20 |
| Jeffamine M2070 | 1 | 2 |
| (ml) | | |
| Biovis (g) | 0.5 (Reported | 0.5 (Reported |
| | as ~1%) | as ~1%) |
| ~% M2070 Conc. | 2% | 4% |

| | |
|---|---|
| Modifying | Add Biovis & adjust pH to ~8.5, add amine |
| Procedure | & HR 16 hrs @150° F. then test |

The results in table 16 demonstrate the effect of barite solids on gel properties in the presence of simulated brine contamination. The sample used was based upon 10 ml fluid taken from the formulations given in table 14.

TABLE 16
Results of tests to summarise the effect of barite solids on gel
properties in the presence of simulated brine contamination

| | | | crosslink | | | | |
|---|---|---|---|---|---|---|---|
| | | | Amine | | | Observations @ | |
| | Mod | | 80% | | Initial | 170° F. over | Hardness |
| Sample | Amine | Barite | ED2003 | Contaminant | Observations | weekend | (g) |
| 65 | 5% M1000 | | 3 | 1 ml CaCl2 | All samples | 3.7 g free liq & | NSFT |
| | | | | (10%) | liquid. Samples | 2 phase gel | |
| 66 | 5% M1000 | 15 | 3 | 1 ml CaCl2 | w/o solids form a | bit pasty | 541 |
| | | | | (10%) | fine droplet | | |
| 67 | 5% M1000 | | 3 | 1 ml KCl | emulsion | Homogeneous gel | 1849 |
| | | | | (8%) | initially | | |
| 67a | 5% M1000 | 15 | 3 | 1 ml KCl | | Homogeneous gel | 1558 |
| | | | | (8%) | | | |
| 68 | 5% M1000 | | 3 | Control | | Homogeneous gel | 3290 |
| 69 | 5% M2070 | | 3 | 1 ml CaCl2 | All samples | 2.6 g free liquid | NSFT |
| | | | | (10%) | liquid. Samples | & 2 phase gel | |
| 70 | 5% M2070 | 15 | 3 | 1 ml CaCl2 | w/o solids form a | bit pasty | 475 |
| | | | | (10%) | fine droplet | | |
| 71 | 5% M2070 | | 3 | 1 ml KCl | emulsion | Homogeneous gel | 1723 |
| | | | | (8%) | initially | | |
| 71a | 5% M2070 | 15 | 3 | 1 ml KCl | | Homogeneous gel | 1686 |
| | | | | (8%) | | | |
| 72 | 5% M2070 | | 3 | Control | | Homogeneous gel | 3657 |

Note -
NSFT = Not suitable for testing

The results in table 16 show that the addition of barite solids reduces the tendency for the gels to collapse with simulated calcium brine contamination. It can be seen that the solids free samples (65 & 69) both collapsed whereas the corresponding barite solids containing samples (66 & 70) did not, although the gels were much weaker than the control. The results also show that the system is much more tolerant to the monovalent KCl brine with good hard homogeneous gels being seen. These results suggest that wellbore mud contamination should be tolerated.

In the test series presented in table 16 the amount of free liquid was weighed after the gel had collapsed due to the addition of brine.

From the data in table 16 it was noted that the M2070 modified sample gives significantly less free liquid (2.6 g) than the M1000 sample (3.7 g) suggesting that the former gel is more swollen in the presence of calcium chloride than the latter, which could be attributed in some way to its higher molecular weight and hence larger chemical structure. In theory, the total amount of water in these samples should approximate to ˜8.7 ml (7.2 ml in the base, 0.6 ml from the 80% ED2003 and ˜0.9 ml from the brine). As approximately 1-(2.6/8.7) or ˜69% of the water is remaining with the gel it can be deduced that the gel is still quite swollen with water in the presence of the brine.

The data in table 17 shows the stabilising effects of Jeffamine M2070, modifying amine, concentration on gel properties in the presence of calcium chloride brine.

TABLE 17
Tests of the effect of modifying amine conc. and aging procedure on gel properties

| | | | Crosslink | | | Observations | |
|---|---|---|---|---|---|---|---|
| | Mod | | Amine | | Initial | after weekend | Hardness |
| Sample | Amine | Notes | 80% ED2003 | Contaminant | Observations | @ 170° F. | (g) |
| 73 | 2% | Brine added | 3 | 1 ml CaCl2 | slight ppt | 3 g free liquid | NSFT |
| | M2070 | directly HR 5 min | | (10%) | initially then | | |
| | | then stood up | | | emulsion, collapsed | | |
| | | static | | | by 1 hr | | |
| 74 | 4% | Brine added | 3 | 1 ml CaCl2 | Emulsion better | Granular gel | 426 |
| | M2070 | directly HR 5 min | | (10%) | compatible than 74, | | |
| | | then stood up | | | collapsed by 1 hr | | |
| | | static | | | | | |
| 75 | 2% | Preage 20 min | 3 | 1 ml CaCl2 | Emulsion better | 8 g free liquid | NSFT |
| | M2070 | before brine HR | | (10%) | compatible than 74, | | |
| | | 5 min then stood | | | collapsed by 1 hr | | |
| | | up static | | | | | |
| 76 | 4% | Preage 20 min | 3 | 1 ml CaCl2 | Emulsion collapsed | Granular gel | 634 |
| | M2070 | before brine HR | | (10%) | by 1 hr | | |
| | | 5 min then stood | | | | | |
| | | up static | | | | | |
| 77 | 2% | Control | 3 | | | Homog Gel | 2893 |
| | M2070 | | | | | | (NF) |
| 78 | 4% | Control | 3 | | | Homog Gel | 4183 |
| | M2070 | | | | | | (NF) |

Note -
NF = gel hardness profile has not peaked by the end of the test i.e. the gel is very elastic and has not failed by that point

The results in table 17 illustrate the effects of the modifying amine concentration and ageing procedure on gel properties. It is shown that a higher level (4%) of the M2070 modified base gives a granular gel in the presence of calcium brine, whereas the 2% gels had both collapsed giving relatively large amounts of free liquid. It is interesting to note that both the 4% samples (74 & 76) initially appeared to have collapsed. However, after aging there was no free liquid suggesting that both gels had become swollen and absorbed the water during the overnight aging process. In addition, the difference between samples 73 & 75 also shows how the aging procedure can effect whether the brine collapses or not. For example pre-aging sample 75 seems to improve the initial stability compared to sample 73, however on aging sample 75 collapses to a greater extent than sample 73 giving 8 g of free liquid vs. 3 g. These results indicate that adjustment of viscosity might be a useful technique to employ in minimising or preventing the gel collapsing in the presence of brine.

The results given in table 18 are based on two samples of “cold rolled” and “heat aged” modified base. These reinforce the theory that the monoamine is actually reacted with the BI and that it is having a beneficial effect with respect to making the system more electrolyte tolerant. These results also demonstrate the useful effects of increasing the levels of Biovis in the formulation.

TABLE 18
Chemical modification of BI and effect of increasing viscosity on gel properties in the presence of electrolyte

| | | Mod | | | | | |
|---|---|---|---|---|---|---|---|
| | Base | Amine | crosslink | | | Observations @ | |
| | 1% | Cold | Amine | | Initial | 170° F. | Hardness |
| Sample | Biovis | Rolled | 80% ED2003 | Contaminant | Observations | after 16 hr | (g) |
| 79 | 10 | 5% M2070 | 3 | Control | | | 606 |
| 80 | 10 | 5% M2070 | 3 | 1 ml CaCl2 | Instant lump does | Collapsed - 9.8 g | NSFT |
| | | | | (10%) | not re-disperse on | free liquid | |
| | | | | | aging | | |
| 81 | 10 | 5% M2070 | 3 | 1 ml KCl | | | 250 |
| | | | | (8%) | | | |
| | 1.5% | | | | | | |
| | Biovis | | | | | | |
| 82 | 10 | 5% M2070 | 3 | Control | | | 1268 |
| 83 | 10 | 5% M2070 | 3 | 1 ml CaCl2 | Instant lump does | Collapsed - 9.8 g | NSFT |
| | | | | (10%) | not re-disperse on | free liquid | |
| | | | | | aging | | |
| 84 | 10 | 5% M2070 | 3 | 1 ml KCl | | | 692 |
| | | | | (8%) | | | |
| 85 | 10 | 5% M2070 | 3 | Control | | Homogeneous gel | 1393 |
| | | | | | | | NF |
| 86 | 10 | 5% M2070 | 3 | 1 ml KCl | Samples form a fine | Homogeneous gel | 1120 |
| | | | | (8%) | droplet emulsion | | |
| 87 | 10 | 5% M2070 | 3 | 1 ml CaCl2 | initially | 2 phase gel | 350 |
| | | | | (10%) | | 1.5 ml | |
| | | | | | | free liquid | |
| | 1.5% | | | | | | |
| | Biovis | | | | | | |
| 88 | 10 | 5% M2070 | 3 | Control | | Homogeneous gel | 3063 |
| | | | | | | | NF |
| 89 | 10 | 5% M2070 | 3 | 1 ml KCl | Samples form a fine | Homogeneous gel | 1971 |
| | | | | (8%) | droplet emulsion | | NF |
| 90 | 10 | 5% M2070 | 3 | 1 ml CaCl2 | initially | Homogeneous gel | 281 |
| | | | | (10%) | | | |

The results in table 18 confirm that the base BI polymer is actually being modified by the modifying amine. It can clearly be seen that the samples (79-84) that have been cold rolled with the M2070 have far less tolerance to brine than the modified samples (85-90) that have been prepared using the preheated modified base. This finding indicates that the chemical structure of the BI polymer has been fundamentally changed.

In more detail samples 80 & 83 give instant precipitation of the polymer on contact with the brine and the gels collapse giving large amounts of free liquid. 9.8 g of free liquid was collected; more than the theoretical amount of water in them, suggesting that either the density of the liquid phase is quite high or some of the amine might not have reacted in these samples. This is in contrast to the heat modified gel fluids that initially form fine emulsions and reasonably homogeneous gels. Furthermore the results for samples 87 & 90 show that increasing the Biovis level from 1% to 1.5%, and hence the viscosity, seems to improve stability further as no free liquid was seen with sample 90.

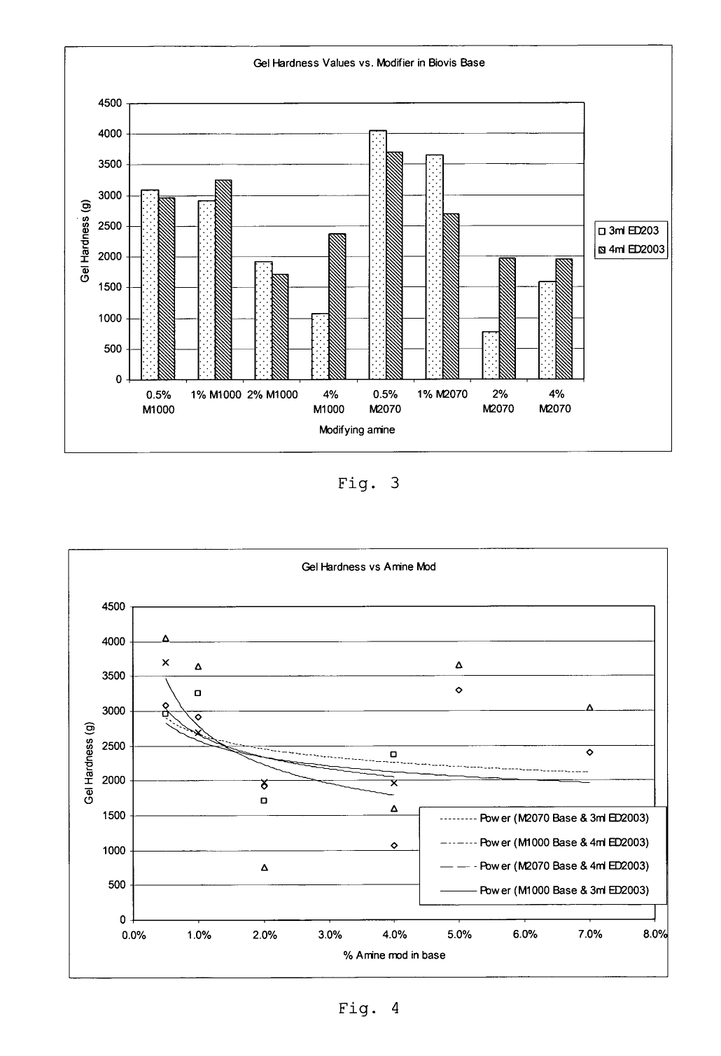

The results in FIGS. 3 and 4 show that stronger gels are produced with the lower concentrations of the two modifying amines than with the higher levels tested. This, may be attributable to a reduction in crosslink density at the raised modification levels. At lower levels M2070 gives harder gels than M1000, which is probably due to the lower number of amine functional groups on the M2070 material leaving more un-reacted isocyanate groups on the BI polymer that can be subsequently cross linked with the ED2003. Although the gels routinely formed are quite consistent with respect to them being homogeneous and of generally good hardness, it can still be seen from the plots in FIG. 4 that the data is quite variable. This variability may be due to differing modification procedures and gel aging times.

Looking in more detail at the trend line results in FIG. 4, it appears that overall 3 ml of the cross linking amine (ED2003) probably gives stronger gels than when 4 ml is used. Furthermore, the gels produced with the M2070 modified Trixene seem to be slightly harder than those from the M1000 modified material.

The results in FIG. 5 show potential methods to improve gel hardness and further reduce the propensity that has been observed for some of the gel formulations to collapse in the presence of calcium chloride brine. Stabilility is improved by using a combination of hydrophilic fumed silica and Biovis. Possibly fumed silica may have practical limitations in the field, however it might be able to be added successfully to the Trixene 7987 in a more controlled chemical plant environment either before or after modification of the BI.

Initial tests were performed where ˜5% fumed silica was added to the base before modification, however this was found to be too much as the samples turned into thick pastes. As a consequence of this tests were repeated at lower doses of ˜1 & 2% fumed silica.

The results in FIG. 5 show that it may be possible to treat a modified base with fumed silica during production, in a controlled chemical plant environment, to improve strength and further reduce the tendency to collapse. This removes the need to add fumed silica at the well site with all its potentially difficult handling issues. All the gels presented in FIG. 5, after aging, were homogenous, even with the addition of brine, although these were roughly an order of magnitude softer than the controls. The samples containing 2% Aerosil fumed silica gave the most consistently hard gels. Adding the fumed silica to the sample before modification (premod) showed little advantage over adding it after modification (postmod) as shown by the “spot check” bars which show similar strengths to “premod” method. This suggests that the material could be easily modified with M2070 and then viscosified with fumed silica before shipping to the well site.

### Example 9

### Consistometer Test on the Internally Stabilised Trixene 7987 & Jeffamine ED2003 System

Approximately 800 ml of base was prepared to the formulation given in table 19.

TABLE 19
Formulation for internally modified Trixene 7987

| Chemical | ml | % v/v |
|---|---|---|
| Trixene 7987 | 60 | 56.3% |
| Water | 40 | 37.6% |
| M2070 | 5 | 4.7% |

Heat age above components for 4 hrs @ 170° F.

| | | |
|---|---|---|
| Biovis | 1.5 | 1.4% |
| Total Vol | 106.5 | 100% |

The Trixene 7987, water, and Jeffamine M2070 were heat aged for 4 hrs at 170° F. by hot rolling in a heat resistant Pyrex bottle in order to react the amine with the BI polymer and modify it. In the morning 303 ml of this composition was used to prepare the two consistometer formulations given in table 20. Two formulations were prepared, the first to get a benchmark set time and the second to see if extra monoamine could be added to extend the set time.

TABLE 20
Formulations used for Consistometer Runs

| | | | | 2^{nd} Run with extra | | |
|---|---|---|---|---|---|---|
| | 1^{st} Run | | | M2070 | | |
| Chemical | | | % v/v | | | % v/v |
| M2070 mod. | 303 | ml | 60.7% | 303 | ml | 57.8% |
| Trixene | | | | | | |
| formulation | | | | | | |
| (from table 27) | | | | | | |
| 80% ED2003 | 91 | ml | 18.2% | 91 | ml | 17.4% |
| UFG Barite | 454 | g | 21.1% | 454 | g | 20.2% |
| Extra M2070 | | | | 24.2 | ml | 4.6% |
| Total Vol | 499.6 | | 100.0% | 523.84 | | 100% |

The Trixene 7987 and M2070 amine were mixed with the water (as in table 19) and the mixture was viscosified with Biovis by adding the polymer and then adjusting the pH to 8 with a few drops of 5N caustic under vigorous agitation (giving the composition as in table 19). After heat aging, the ED2003 was added and mixed until homogeneous this was then followed by addition of the barite.

The runs were performed on the Nowsco Consistometer using a ramp up time of 17 min to 75° C. and a paddle speed of 20 rpm. The speed was kept low to avoid contamination of the sample with hydraulic oil. There was initially quite a lot of expansion on heat up so the pressure needed to be carefully maintained at 2000 psi.

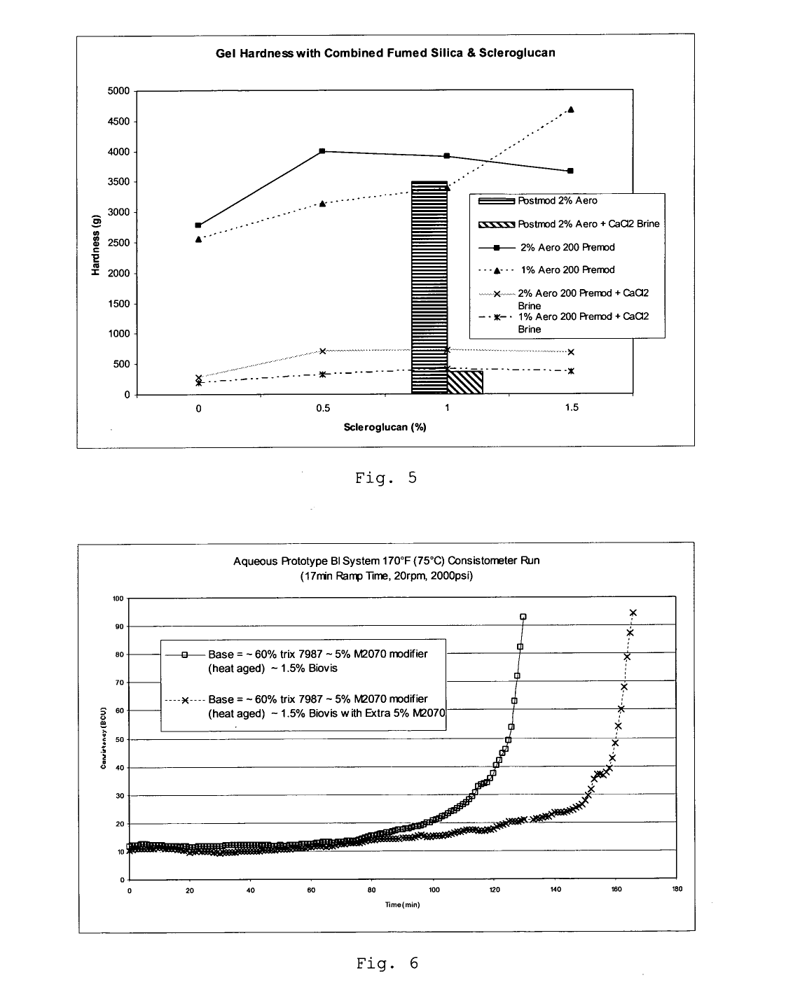

The results of the consistometer tests, given in FIG. 6, indicate that a viable system has been developed that is suitable for use at temperatures up to 170° F. (75° C.). It can be seen that the modified base has a very useable gel time of around 2 hours (allowing sufficient time to be injected into a wellbore before gelation). Interestingly it is also noted that this can be extended by approximately another 40 minutes by adding extra monoamine to the formulation. This extra addition will reduce the cross link density and soften the gel somewhat but may still be a useful tool to use in order to extend the temperature range, (up to 80 or possibly even 85° C.)

These results show that by using modified Trixene 7987 electrolyte tolerant gels can be produced. These are suitable for lower temperature applications. If higher temperature tolerance is required, the skilled person can prepare compositions with more tightly bound blocking agents to delay unblocking of the isocyanate, and hence gel formation, until a higher temperature is reached.

1-15. (canceled)

16. A wellbore fluid comprising
(i) a blocked isocyanate having a tolerance improving group bonded to it; and
(ii) an active hydrogen component
wherein the tolerance improving group increases the tolerance of the blocked isocyanate to an inorganic brine contaminant compared to the corresponding unmodified blocked isocyanate.

17. The wellbore fluid of claim 16, wherein the tolerance improving group is a hydrophilic group.

18. The wellbore fluid of claim 17, wherein the tolerance improving group is an amine.

19. The wellbore fluid of claim 18, wherein the tolerance improving group is selected from alkanolamines, alkyl alkanolamines, ethylene amines, and polyether amines.

20. The wellbore fluid of claim 19, wherein the tolerance improving group is a polyether amine.

21. The wellbore fluid of claim 20, wherein the polyether amine comprises a molecular backbone formed from ethylene oxide and propylene oxide units.

22. The wellbore fluid of claim 16, wherein the tolerance improving group is bonded to the blocked isocyanate via one or more of the blocked isocyanate isocyanate groups.

23. The wellbore fluid of claim 22, wherein 2 to 30% of the isocyanate groups of the block isocyanate component have tolerance improving groups bonded thereto.

24. The wellbore fluid of claim 16, wherein the active hydrogen component is an alcohol or an amine compound.

25. The wellbore fluid of claim 24, wherein the active hydrogen component is a polyether amine.

26. The wellbore fluid of claim 16, wherein the wellbore fluid further comprises at least one selected from the group consisting of barite, scleroglucan, and silica.

27. A method of treating an earthen formation comprising:
circulating a wellbore fluid downhole, wherein the wellbore fluid comprises:
(i) a blocked isocyanate having a tolerance improving group bonded to it; and
(ii) an active hydrogen component
wherein the tolerance improving group increases the tolerance of the blocked isocyanate to an inorganic brine contaminant compared to the corresponding unmodified blocked isocyanate.

28. The method of claim 27, further comprising unblocking the blocked isocyanate in the presence of the active hydrogen component to form a gel downhole.

29. The method of claim 28, wherein the blocked isocyanate component and the active hydrogen component are introduced downhole separately.

30. The method of claim 29, wherein the unblocking step occurs subsequent to contacting the blocked isocyanate component and the active hydrogen component.

31. The method of claim 28, wherein the blocked isocyanate component and the active hydrogen component are introduced downhole concurrently.

32. The method of claim 27, wherein the tolerance improving group is a hydrophilic group.

33. The method of claim 32, wherein the tolerance improving group is an amine.

34. The method of claim 33, wherein the tolerance improving group is selected from alkanolamines, alkyl alkanolamines, ethylene amines, and polyether amines.

35. The method of claim 34, wherein the tolerance improving group is a polyether amine.

36. The method of claim 35, wherein the polyether amine comprises a molecular backbone formed from ethylene oxide and propylene oxide units.

37. The method of claim 27, wherein the tolerance improving group is bonded to the blocked isocyanate via one or more of the blocked isocyanate isocyanate groups.

38. The method of claim 37, wherein 2 to 30% of the isocyanate groups of the block isocyanate component have tolerance improving groups bonded thereto.

39. The method of claim 27, wherein the active hydrogen component is an alcohol or an amine compound.

40. The method of claim 39, wherein the active hydrogen component is a polyether amine.

41. The method of claim 27, wherein the wellbore fluid further comprises at least one selected from the group consisting of barite, scleroglucan, and silica.
